(19) United States
(12) Patent Application Publication
(10) Pub. No.: US 2026/0194720 A1
(43) Pub. Date: Jul. 9, 2026

(54) OPTICAL CONNECTOR WITH PULLABLE HOUSING, AND RELATED METHODS

(71) Applicant: CORNING RESEARCH & DEVELOPMENT CORPORATION, CORNING, NY (US)

(72) Inventors: Louis Edward Parkman, III, Keller, TX (US); Diana Rodriguez, Mansfield, TX (US)

(21) Appl. No.: 19/557,854

(22) Filed: Mar. 5, 2026

Related U.S. Application Data
(63) Continuation of application No. PCT/US2024/045757, filed on Sep. 9, 2024.
(60) Provisional application No. 63/537,294, filed on Sep. 8, 2023.

(51) Int. Cl. G02B 6/38

(52) U.S. Cl. CPC G02B 6/3887

(57) ABSTRACT

The present disclosure relates to a telecommunications connector. The connector includes at least one connector portion including a front housing portion coupled to a rear housing portion. The front housing portion defines a front end and a rear end, the front housing portion including a ferrule terminating a cable fixed to the at least one connector portion, the front housing portion further including a latch that is configured to contact a fiber optic adapter for locking the connector to the fiber optic adapter when the connector is inserted into the fiber optic adapter, wherein the latch is movable about a connection location on the front housing portion. The latch defines a permanently attached rear extension that extends rearward past the rear end of the front housing portion, the rear extension configured to be contacted for moving the latch for freeing the connector from the fiber optic adapter.

### PRIORITY APPLICATION

This application is a continuation of International Application No. PCT/US2024/045757, filed on Sep. 9, 2024, which claims the benefit of priority to U.S. Application No. 63/537,294, filed on Sep. 8, 2023, both applications being incorporated herein by reference.

### BACKGROUND

This disclosure relates generally to telecommunication cable assemblies, such as optical cable assemblies. More particularly, this disclosure relates to optical connectors, optical interconnection assemblies that include an optical connector and a receptacle configured to receive the optical connector, and methods of reversing polarity of optical connectors.

In a telecommunications system that uses optical fibers, there are typically many locations where cables that carry the optical fibers connect to equipment or other cables. Optical connectors are often provided on the ends of the cables to conveniently provide these connections. The connectors are designed to engage adapters that align the connectors with other connectors or other components so that data can be transmitted between the mated components.

Some connectors include one or more latch arms that extend outwardly from a connector body. Each latch arm is designed to engage the adapter in a manner that retains the connector in the adapter. To remove the connector from the adapter, each latch arm is first flexed toward the connector body to release the engagement with the adapter. Some connectors are designed with components to assist such flexing/actuation of the latch arm(s) and, in some cases, also assist with removing the connector from an adapter.

For example, LC connectors are widely used in data centers and other environments where a high density of optical connections are desired. These types of connectors are often used in a duplex configuration due to the bi-directional nature of data center networks. Many LC duplex connector designs integrate two LC connector sub-assemblies with a common boot (“uniboot”) to terminate a two-fiber cable or a two-fiber fanout leg of a larger cable. Some of the designs include a housing, pull tab, or some other component configured to assist with actuating the latch arms of the connector sub-assemblies. The designs, however, can be relatively complex, perform poorly, have limited functionality, and/or require a large number of specially-designed components.

Similar challenges exist with respect to other features for duplex connectors. For example, many LC duplex uniboot connectors are configured to allow polarity of the connector to be reversed. Polarity exists because one of the LC connector sub-assemblies transmits data in one direction (an “A” direction) and the other LC connector sub-assembly transmits data in an opposite direction (a “B” direction), such that the duplex connector may have an A-B configuration or B-A configuration with respect to a defined orientation of the connector. Changing from one configuration to other in the field can be desirable, and many designs now exist with this feature. However, the designs can require complex components or processes to reverse polarity.

As can be appreciated, designing duplex connectors (and especially LC duplex uniboot connectors) with multiple features can be challenging, and there remains room for improvement over known designs.

### SUMMARY

According to one aspect of this disclosure, an optical connector includes: a first connector sub-assembly that is configured to terminate a first optical fiber; a second connector sub-assembly that is configured to terminate a second optical fiber; an inner housing that holds a rear portion of the first connector sub-assembly and a rear portion of the second connector sub-assembly so that the first connector sub-assembly and the second connector sub-assembly extend forward from a front portion of the inner housing; an outer housing positioned over at least a rear portion of the inner housing; and a boot extending rearward from the outer housing. The outer housing is movable along a longitudinal axis of the optical connector and relative to the inner housing between a forward position and a rear position, and the boot is axially coupled to the outer housing so that the boot is configured to move with the outer housing along the longitudinal axis. The inner housing includes at least one stopping feature configured to contact the outer housing when the outer housing is moved to the rear position. The at least one stopping feature is configured to retain the outer housing on at least the rear portion of the inner housing.

In some embodiments, the outer housing is rotatable relative to the inner housing about the longitudinal axis when the outer housing is in the rear position but not when the outer housing is in the forward position. One example of how this may be achieved is by the outer housing including an inner wall that defines a flange, and by the rear portion of the inner housing including a groove that extends at least partially in a circumferential direction about the longitudinal axis. The groove is configured to receive the flange when the outer housing is in the rear position and rotated about the longitudinal axis. In other words, in such embodiments, alignment between the flange and groove allows for the rotation.

As a further aspect, some embodiments may be configured such that in the rear position of the outer housing, the outer housing is rotatable 180 degrees about the longitudinal axis between a first orientation and a second orientation. Indeed, embodiments are possible where the outer housing is configured to rotate no more than approximately 180 degrees. Furthermore, some embodiments may include the inner housing being configured to allow the outer housing to rotate in only one direction from the first orientation to the second orientation and in only an opposite direction from the second orientation to the first orientation. Another optional feature that may be advantageous is the inner housing being configured to substantially prevent relative movement of the outer housing along the longitudinal axis when the outer housing is rotating between the first orientation and the second orientation.

In some embodiments, the first connector sub-assembly and the second connector sub-assembly each include a connector body having a main portion and a latch arm that extends over the main portion. When the outer housing is in the forward position, the outer housing extends partially over the latch arm of the first connector sub-assembly and the latch arm of the second connector sub-assembly. Additionally, the outer housing is configured to cause the latch arms to flex toward the main portion of the respective connector body when the outer housing moves along the longitudinal axis from the forward position towards the rear position. Some embodiments may also be configured such that in the rear position of the outer housing, the outer housing does not extend over the latch arms of the first connector sub-assembly and the second connector sub-assembly.

In some embodiments, the rear portions of the first and second connector sub-assemblies are held by the inner housing in a manner that allows the rear portions to rotate about a respective connector sub-assembly axis. Each rear portion may be defined by a connector body or another component of the first or second connector sub-assembly, such as a rear stopper component that is rotationally and axially coupled to the connector body. Thus, the respective connector bodies of the first and second connector sub-assemblies in such embodiments are configured to rotate relative to the inner housing about the respective connector sub-assembly axis.

Another optional aspect in embodiments according to the preceding paragraph is the rear portion of each of the first and second connector sub-assemblies including a plurality of rotation locking features circumferentially arranged about the respective connector sub-assembly axis. Additionally, the inner housing may include at least one complementary locking feature configured to releasably engage at least one of the rotation locking features so that the respective connector sub-assembly can be indexed to different rotational positions about the respective connector sub-assembly axis. One example is the rear portions of the first and second connector sub-assemblies each including a radial flange with a plurality of notches that define the plurality of rotation locking features, and the at least one complementary locking feature on the inner housing comprising a flexible member that releasably engages at least one of the notches in each of the different rotational positions to which the respective connector sub-assembly can be indexed.

In some embodiments, the first connector sub-assembly and the second connector sub-assembly each extend along a respective connector sub-assembly axis. The inner housing may also include an inner cavity that extends from the first and second connector sub-assemblies toward the rear portion of the inner housing. For such embodiments, in a transverse plane that extends through the inner housing and the connector sub-assembly axes: (i) the inner cavity may include first and second lateral sides that transition the inner cavity from a first width at a front region of the inner cavity to a second width at a rear region the inner cavity, with the second width being less than a pitch distance between the connector sub-assembly axes, and (ii) the first and second lateral sides may each have a profile defined by at least an arc-shaped segment that extends from the rear region of the inner cavity toward the front region and that curves outward so as to be convex relative to the inner cavity.

Embodiments according to the preceding paragraph may have more than one arc-shaped segment defining the profile of each of the first and second lateral sides. For example, in some embodiments, for each of the first and second lateral sides, the respective arc-shaped segment that extends from the rear region of the inner cavity may be considered as a second arc-shaped segment. The profiles for the first and second lateral sides may each further be defined by a respective first arc-shaped segment that extends from the front region of the inner cavity toward the rear region of the inner cavity. The first arc-shaped segment for each of the first and second lateral sides extends a first length and curves inward so as to be concave relative to the inner cavity. Some embodiments may include the first arc-shaped segment and the second arc-shaped segment being continuous and defining an s-shaped curve for the associated first or second lateral side.

In some embodiments, an optical connector according to any of the preceding paragraphs includes the first connector sub-assembly and the second connector sub-assembly being configured for mating with an LC receptacle that has a mechanical reference plane and geometry according to a senior adapter or active device receptacle in intermateability standard IEC 61754-20 (e.g., revision 2012+AMD1:2022 and/or other revisions) or TIA/EIA 604-10 (e.g., revision C:2021 and/or other revisions) such that the LC receptacle includes a front wall that defines a front plane spaced from the mechanical reference plane of the LC receptacle by a first port distance. Components of the optical connector may then have specific geometries to provide novel and advantageous features. As a first example, in some embodiments the first and second connector sub-assemblies define a mechanical reference plane that is spaced from a front side of the inner housing by a first connector latching distance along the longitudinal axis of the optical connector. The first port distance is greater than the first connector latching distance so that the inner housing is configured to extend into ports of the LC receptacle when the optical connector is mated with the LC receptacle. Such a feature may help with the distribution of stresses from side loads that the optical connector may experience when mated with the LC receptacle.

As a second example according to the preceding paragraph, alone or in combination with the first example, the first and second connector sub-assemblies define a mechanical reference plane that is spaced from a front side of the inner housing by a first connector latching distance along the longitudinal axis of the optical connector. The outer housing may include lateral sidewalls that each have a front side. The front side of each of the lateral sidewalls of the outer housing may be spaced from the mechanical reference plane of the first and second connector sub-assemblies by at most a second connector latching distance along the longitudinal axis of the connector. The second connector latching distance may be less than 15% larger than the first port distance such that the front side of each of the lateral sidewalls of the outer housing may be configured to be less than 15% further from the mechanical reference plane of the LC receptacle than the front wall of the LC receptacle when the optical connector is mated with the LC receptacle. Such a feature contributes to the connector sub-assemblies and inner housing being substantially concealed when the optical connector is mated with the receptacle.

Various features mentioned above as being applicable to some embodiments of an optical connector according to the first paragraph of this Summary section are also disclosed herein as being applicable to optical connectors that may not necessarily be according to the first paragraph of this Summary section. To this end, persons skilled in optical connectivity will understand that some features provided in this disclosure may be complementary, but not inextricably linked. The context in which the various features are provided in this disclosure as a whole will make this apparent. As an example, the present disclosure also provides for embodiments of an optical connector that comprises: a first connector sub-assembly that is configured to terminate a first optical fiber and support the first optical fiber along a first connector sub-assembly axis; a second connector sub-assembly that is configured to terminate a second optical fiber and support the second optical fiber along a second connector sub-assembly axis; and a housing that holds a rear portion of the first connector sub-assembly and a rear portion of the second connector sub-assembly so that the first connector sub-assembly and the second connector sub-assembly extend forward from a front portion of the housing, wherein the housing also includes an inner cavity that extends from the first and second connector sub-assemblies toward a rear portion of the housing. In a transverse plane that extends through the housing and the first and second connector sub-assembly axes: (i) the inner cavity includes first and second lateral sides that transition the inner cavity from a first width at a front region of the inner cavity to a second width at a rear region the inner cavity, with the second width being less than a pitch distance between the first and second connector sub-assembly axes, and (ii) the first and second lateral sides each have a profile defined by at least an arc-shaped segment that extends from the rear region of the inner cavity toward the front region and that curves outward so as to be convex relative to the inner cavity.

Embodiments according to the example in the preceding paragraph may have more than one arc-shaped segment defining the profile of the first and second lateral sides. For example, in some embodiments, for each of the first and second lateral sides, the respective arc-shaped segment that extends from the rear region of the inner cavity may be considered as a second arc-shaped segment. The profiles for the first and second lateral sides may each further be defined by a respective first arc-shaped segment that extends from the front region of the inner cavity toward the rear region of the inner cavity. The first arc-shaped segment for each of the first and second lateral sides extends a first length and curves inward so as to be concave relative to the inner cavity. Some embodiments may include the first arc-shaped segment and the second arc-shaped segment being continuous and defining an s-shaped curve for the associated first or second lateral side.

As another example not necessarily according to the first paragraph of this Summary section, the present disclosure also provides for embodiments of an optical connector for mating with an LC receptacle, wherein the LC receptacle has a mechanical reference plane and geometry according to a senior adapter or active device receptacle in intermateability standard IEC 61754-20 (e.g., revision 2012+AMD1:2022 and/or other revisions) or TIA/EIA 604-10 (e.g., revision C:2021 and/or other revisions) such that the LC receptacle includes a front wall that defines a front plane spaced from the mechanical reference plane of the LC receptacle by a first port distance. Such an optical connector according to this disclosure comprises: a first connector sub-assembly and a second connector sub-assembly that each include a respective connector body configured to be received in the LC receptacle; and a housing that holds a rear portion of the first connector sub-assembly and a rear portion of the second connector sub-assembly. The first and second connector sub-assemblies each extend from a front side of the housing and define a mechanical reference plane that is spaced from the front side of the housing by a first connector latching distance along a longitudinal axis of the optical connector. The first port distance is greater than the first connector latching distance so that the inner housing is configured to extend into ports of the LC receptacle when the optical connector is mated with the LC receptacle.

As yet another example not necessarily according to the first paragraph of this Summary section, the present disclosure also provides for embodiments of an optical connector for mating with an LC receptacle, wherein the LC receptacle has a mechanical reference plane and geometry according to a senior adapter or active device receptacle in intermateability standard IEC 61754-20 (e.g., revision 2012+AMD1:2022 and/or other revisions) or TIA/EIA 604-10 (e.g., revision C:2021 and/or other revisions) such that the LC receptacle includes a front wall that defines a front plane spaced from the mechanical reference plane of the LC receptacle by a first port distance. Such an optical connector according to this disclosure comprises: a first connector sub-assembly and a second connector sub-assembly that each include a respective connector body configured to be received in the LC receptacle; an inner housing that holds a rear portion of the first connector sub-assembly and a rear portion of the second connector sub-assembly so that the first connector sub-assembly and the second connector sub-assembly extend forward from a front portion of the inner housing; and an outer housing positioned over at least a rear portion of the inner housing. The front side of each of the lateral sidewalls of the outer housing is spaced from the mechanical reference plane of the first and second connector sub-assemblies by at most a connector latching distance along the longitudinal axis of the connector. The connector latching distance is less than 15% larger than the first port distance such that the front side of each of the lateral sidewalls of the outer housing are less than 15% further from the mechanical reference plane of the LC receptacle than the front wall of the LC receptacle when the optical connector is mated with the LC receptacle.

Another aspect of this disclosure is an optical interconnection assembly that includes at least one of the optical connectors introduced in this disclosure and at least one of the receptacles introduced in this disclosure (e.g., an LC receptacle like those mentioned above).

Another aspect of this disclosure is an optical cable assembly that includes at least one of the optical connectors introduced in this disclosure. For example, embodiments are provided of an optical cable assembly that comprises: a first optical fiber; a second optical fiber; and an optical connector according to any of the preceding paragraphs, wherein the first connector sub-assembly of the optical connector terminates the first optical fiber and the second connector sub-assembly terminates the second optical fiber. The optical cable assembly may consist only of the first and second optical fibers, or may include more optical fibers that may or may not be terminated by other optical connectors according to this disclosure.

This disclosure also provides methods of changing polarity of an optical connector. According to some embodiments, the method is for an optical connector that includes a first connector sub-assembly terminating a first optical fiber, a second connector sub-assembly terminating a second optical fiber, an inner housing that holds a rear portion of the first connector sub-assembly and a rear portion of the second connector sub-assembly so that the first connector sub-assembly and the second connector sub-assembly extend forward from a front portion of the inner housing, an outer housing positioned over at least a rear portion of the inner housing, and a boot extending rearward from the outer housing. The method comprises moving the outer housing along a longitudinal axis of the optical connector and relative to the inner housing from a forward position to a rear position, wherein the boot is axially coupled to the outer housing so that the boot moves with the outer housing along the longitudinal axis, and wherein the inner housing includes at least one stopping feature that contacts the outer housing when the outer housing is moved to the rear position, the at least one stopping feature being configured to retain the outer housing on at least the rear portion of the inner housing. The method also comprises: rotating the first connector sub-assembly and the second connector sub-assembly by 180 degrees about respective connector sub-assembly axes that are each parallel with the longitudinal axis; rotating the outer housing 180 degrees about the longitudinal axis so that the outer housing rotates between a first orientation and a second orientation; and moving the outer housing from the rear position to the forward position when the outer housing is in the second orientation.

The order of steps in methods according to the preceding paragraph may vary. For example, the step of rotating the first connector sub-assembly and the second connector sub-assembly by 180 degrees may be performed before or after the step of moving the outer housing along the longitudinal axis from the forward position to the rear position.

The methods mentioned above may also include features to assist a user with the various steps. For example, in some embodiments the step of rotating the outer housing 180 degrees includes substantially limiting movement of the outer housing along the longitudinal axis while the outer housing is being rotated. As another example, in some embodiments the boot is rotationally coupled to the outer housing such the step of rotating the outer housing 180 degrees comprises rotating the outer housing or the boot to cause both the outer housing and the boot to rotate about the longitudinal axis. As yet another example, in some embodiments the inner housing is configured to prevent the outer housing from rotating to the second orientation until the outer housing is moved to the rear position. As yet another example, in some embodiments the inner housing is configured to allow the outer housing to rotate in only one direction from the first orientation to the second orientation and in only an opposite direction from the second orientation to the first orientation.

Additional features will be set out in the detailed description which follows, and in part will be readily apparent to those skilled in the technical field of optical connectivity. The same can be said with respect to advantages for the various features set out in this disclosure. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of one embodiment of an optical connector according to this disclosure mated with an adapter, wherein the optical connector is part of a cable assembly.

FIG. 2 is an exploded perspective of the optical connector of FIG. 1.

FIG. 3A is a side view of the optical connector of FIG. 1, and FIG. 3B is a cross-sectional view of the area circled in FIG. 3A to show a relationship between certain components of the optical connector.

FIG. 4 is a cross-sectional side view of a connector sub-assembly used in the optical connector of FIG. 1.

FIG. 5 is an exploded perspective view of an end section of an optical cable and various components of the optical connector of FIG. 1, namely a transition tube, crimp band, and heat shrink tube.

FIG. 6 is a perspective view illustrating the end section of the optical cable of FIG. 5 secured to the components of the optical connector that are shown in FIG. 5.

FIG. 7 is a perspective view of the optical connector of FIG. 1 installed on the optical cable of FIGS. 5 and 6, but with various components of the optical connector not shown to better view an inner housing and first and second connector sub-assemblies that have rear stopper components received in a front portion of the inner housing, wherein the components of the optical connector that are shown in FIG. 6 are received in a rear portion of the inner housing.

FIG. 8 is a perspective view similar to FIG. 7, but shows a lid of the inner housing exploded from a base of the inner housing to better view how components of the optical connector are received in the inner housing.

FIG. 9 is a perspective view of an example rear stopper component for the first and second connector sub-assemblies.

FIG. 10 is another perspective view of the inner housing and connector sub-assemblies, wherein the components are shown from a different viewpoint to further illustrate how the front portion of the inner housing may receive and interact with the rear stopper components of the connector sub-assemblies.

FIG. 11 is a cross-sectional perspective view of the optical connector of FIG. 1 to further illustrate how: (i) base and the lid of the inner housing couple together in the embodiment shown, and (ii) the inner housing interacts with rear stopper components of the first and second connector sub-assemblies.

FIG. 12 is a perspective view of an outer housing of the optical connector of FIG. 1.

FIG. 13 is a perspective view of a boot of the optical connector of FIG. 1, wherein the boot includes a substrate and a strain relief component.

FIG. 14 is a cross-sectional perspective view of a portion of the optical connector of FIG. 1 and shows how the outer housing of FIG. 12 and the boot of FIG. 13 may interact and couple together.

FIG. 15 is a cross-sectional perspective view of the outer housing of the optical connector of FIG. 1.

FIG. 16 is an enlarged perspective view of the rear portion of the inner housing of the optical connector of FIG. 1.

FIG. 17 is a perspective view of the inner housing and outer housing of the optical connector of FIG. 1, wherein a portion of the outer housing is partially cut-away to better view relationships between the inner housing and outer housing.

FIG. 18 is a front cross-sectional view of the optical connector of FIG. 1, with the cross-sectional plane being selected to further illustrate relationships between the inner housing and outer housing.

FIG. 19 is a side view of the optical connector and adapter of FIG. 1, partially shown in cross-section.

FIG. 20 is a side view similar to FIG. 19, but with the boot and outer housing of the optical connector in a retracted position relative to a remainder of the optical connector, and schematically illustrates how the outer housing is configured to depress latch arms of the first and second connector sub-assemblies when moving to the retracted position.

FIG. 21 is a perspective view similar to FIG. 17, but illustrates the outer housing moved axially to a rear position relative to the inner housing.

FIG. 22 is an enlarged perspective view illustrating how the outer housing of the optical connector of FIG. 1 contacts a stopping feature defined by the rear portion of the inner housing when the outer housing is moved axially to the rear position, wherein a portion of the outer housing is cut-away to better show the interaction.

FIG. 23 is an enlarged perspective view illustrating the outer housing and inner housing in the same position as FIG. 22, but FIG. 23 shows an opposite side of the components.

FIGS. 24-31 are perspective views sequentially illustrating a process for reversing polarity of the optical connector of FIG. 1.

FIG. 32 is an enlarged perspective view of a portion of an optical connector that includes an alternative boot design, and specifically an alternative substrate design, wherein the outer housing of the optical connector is hidden to better visualize the arrangement of the substrate of the boot and the rear portion of the inner housing, and wherein the boot is in a rotational position that represents an unlocked position.

FIG. 33 is another enlarged perspective view similar to FIG. 32, but shows the boot rotated to a different rotational position that represents a locked position.

FIG. 34 is an enlarged top view further illustrating the relationship between the substrate of the boot and the rear portion of the inner housing when the boot is in the locked position.

FIG. 35 is a perspective view of the boot coupled to the outer housing of the optical connector of FIG. 1, wherein the boot is shown in the locked position.

FIG. 36 is a side view of the optical connector and adapter of FIG. 1 with annotations added to facilitate discussion.

FIG. 37 is an enlarged side view of a portion of the optical connector of FIG. 1 with annotations added to facilitate discussion.

FIG. 38 is a schematic top view of a portion of the optical connector of FIG. 1, and specifically the base of the inner housing holding the connector sub-assemblies, wherein optical fibers are illustrated extending from the connector sub-assemblies into an inner cavity of the inner housing.

FIG. 39 is an enlarged schematic view of the inner cavity of the inner housing with annotations added to facilitate discussion.

FIG. 40 is a schematic diagram showing an example of how an optical fiber may extend through components of an optical connector according to this disclosure, and how that optical fiber may be forced to deviate from a normal path of travel to accommodate excess fiber length.

FIG. 41 is a perspective view of components of an optical connector according to an alternative embodiment, and specifically of an alternative embodiment of an inner housing and rear stopper components.

FIG. 42 is a perspective view similar to FIG. 41, but with a lid of the inner housing exploded from a base of the inner housing to better view how the rear stopper components are received in the front portion of the inner housing.

### DETAILED DESCRIPTION

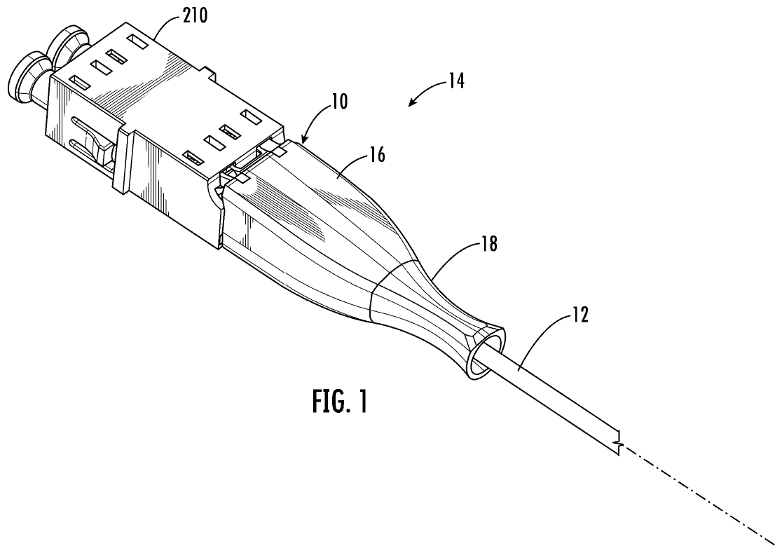

Various embodiments will be further clarified by examples in the description below. In general, the description relates to optical connectors and cable assemblies including the same. FIG. 1 illustrates one example of an optical connector 10 (also referred to as “fiber optic connector 10”, or simply “connector 10”) mated with an adapter 210. The connector 10 terminates a cable 12 and thereby represents a portion of a cable assembly 14. As can be seen in FIG. 1, the connector 10 has a low profile and relatively short length. This compact footprint/design facilitates installation in patch panels and other equipment where there is a high density of adapters or receptacles that may be populated with respective connectors on the ends of respective cables or cable legs. The compact design remains user-friendly, however, with only an outer housing 16 and a boot 18 of the connector presented to a user when the connector 10 is mated with the adapter 210, and as will be described in greater detail below, with these components functioning together to assist the user with removing the connector 10 from the adapter 210. In essence, a user can pull any visible surface of the connector 10 to remove the connector 10 from the adapter 210, thereby avoiding doubt and uncertainty for such removal. Additional features on the connector 10 are provided to also help avoid doubt, uncertainty, and/or errors when reversing polarity of the connector 10. These and other aspects will be described in further detail below after first providing a general overview of the connector 10.

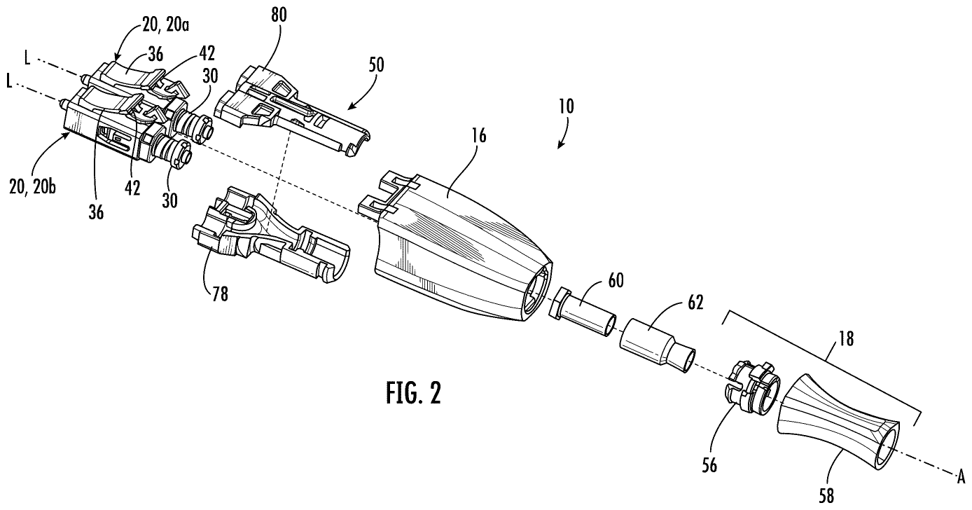

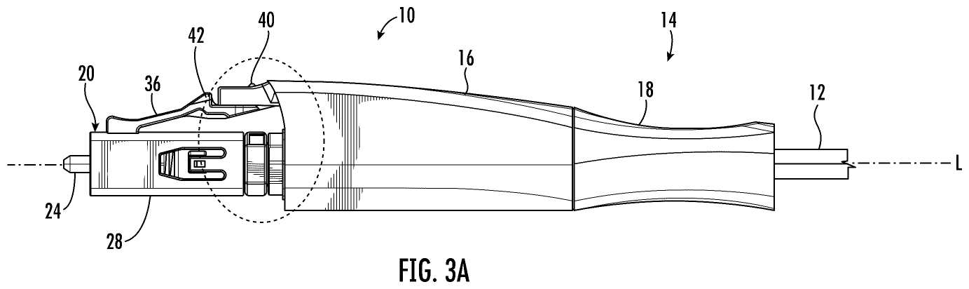

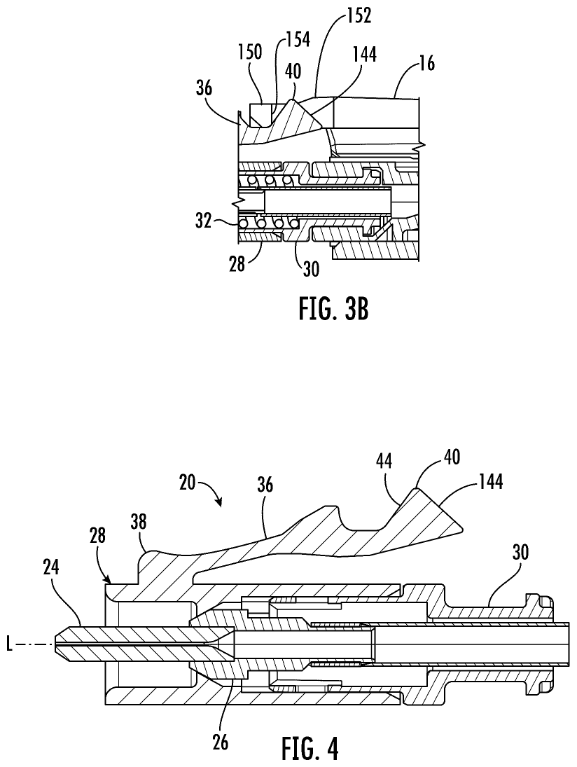

To this end, FIGS. 2 and 3A illustrate the connector 10 by itself. The connector 10 is shown in the form of an LC duplex connector (e.g., according to IEC 61754-20:2012+AMD1:2022 or TIA/EIA 604-10-C:2021) having first and second LC connector sub-assemblies 20a, 20b. Reference number 20 will be used for convenience to generically refer to both the first and second connector sub-assemblies 20a, 20b in the remainder of this Detailed Description since the first and second connector sub-assemblies 20a, 20b have the same construction in the embodiment shown. However, the connector 10 is merely an example, and persons skilled in optical connectivity will appreciate that features provided in this disclosure may apply to other connector designs, including other types of duplex connectors, or even simplex connectors and multifiber connectors.

As shown in FIGS. 2 and 3A, the connector 10 extends along a longitudinal axis A, which is generally centered between the connector sub-assemblies 20 and runs along a length of the connector 10. The connector sub-assemblies 20 each extend along a respective longitudinal axis L that is generally parallel to the longitudinal axis A. In this disclosure, references to components rotating refer to rotation about the longitudinal axis A or one of the longitudinal axes L, the context being clear which is applicable. Each longitudinal axis L is referred to below as a connector sub-assembly axis L to better distinguish from the longitudinal axis A. In simplex connector embodiments (not shown), the longitudinal axis A and the connector sub-assembly axis L may be the same.

Additionally, as used in this disclosure, references to “axial movement,” “moving axially,” “in an axial direction,” or the like refer to movement along or parallel to the longitudinal axis A. Furthermore, the terms “forward” (or “front”) and “rearward” (or “backward” or “rear” or “back”) are relative terms that generally use the orientation of the connector 10 as a reference. For example, a front of the connector 10 is defined by the connector sub-assemblies 20 (e.g., where the connector sub-assemblies 20 present ends of optical fibers for optical coupling with another connector or device), and a rear of the connector 10 is defined where the boot 18 of the connector 10 stops extending over the cable 12 (FIG. 1). Thus, a forward direction is a direction from the rear of the connector 10 toward the front of the connector 10, along or parallel to the longitudinal axis A. A rearward or backward direction is a direction from the front of the connector 10 toward the rear of the connector 10, along or parallel to the longitudinal axis A. Various components are described in this disclosure as moving forward or rearward relative to one another, and/or moving axially forward or axially rearward.

As shown in FIG. 4, each connector sub-assembly 20 includes a ferrule 24 configured to support an optical fiber 22 (FIG. 6) and a connector body 28 (also referred to as “connector sub-assembly housing 28” or simply “housing 28”) surrounding a portion of the ferrule 24. The ferrule 24 extends from a ferrule holder 26 that is retained in the connector body 28. In particular, internal geometry of the connector body 28 prevents the ferrule holder 26 from exiting a front of the connector body 28, and a rear stopper component 30 that is coupled to the connector body 28 prevents the ferrule holder 26 from exiting a rear of the connector body 28. A spring 32 (not shown in FIG. 4 but see FIG. 3B) biases the ferrule holder 26 forward within the connector body 28, away from the rear stopper component 30, so that a front end of the ferrule 24 projects beyond the connector body 28. The front end of the ferrule 24 presents the optical fiber 22 for optical coupling with a mating device (e.g., another optical connector).

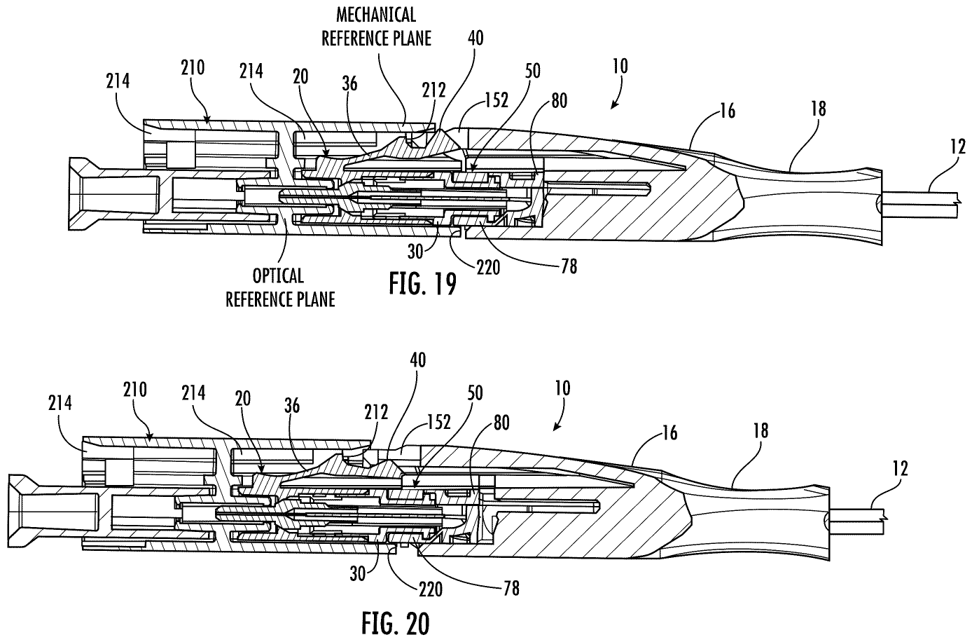

Each connector sub-assembly 20 also includes a latch arm 36 extending outwardly and rearwardly from a front portion of the connector body 28. Thus, the latch arm 36 has a proximal end portion 38 coupled to the front portion of the connector body 28, a distal end portion 40 spaced from the connector body 28, and latching features 42 (FIG. 2) between the proximal end portion 38 and distal end portion 40. The latch arm 36 may be depressed or otherwise flexed toward the connector sub-assembly axis L to release the latching features 42 from engagement with corresponding latching features 212 (FIG. 19) of the adapter 210. Thus, as used in this disclosure, references to the latch arm 36 depressing or being depressed refer to intentional movement of the latch arm 36 for assisting with or causing disengagement from an adapter or other receptacle. That is, depressing the latch arm 36 in this disclosure refers to actuation or movement for a desired purpose; something more than incidental flexing or movement of the latch arm 36 downward that would not affect engagement with an adapter or otherwise cause the latching features 42 to move a relevant amount. In the embodiment shown, the latch arm 36 is formed integrally with the connector body 28 such that the latch arm 36 is configured to flex toward a main portion of the connector body 28. In alternative embodiments, the latch arm 36 may be a different component coupled either to the connector body 28 or another component. As will be described in greater detail below, in the embodiment shown, the distal end portion 40 of the latch arm 36 defines a ramp or actuation surface 44 to assist with removing the connector 10 from a receptacle (e.g., adapter 210).

FIGS. 2 and 3A illustrate how the connector 10 further includes an inner housing 50 that holds a rear portion of each connector sub-assembly 20. Such rear portions in the embodiment shown are defined by the rear stopper components 30. In alternative embodiments, the rear portions of the connector sub-assemblies 20 may be defined by the connector bodies 28 or some other structure. The connector 10 also includes an outer housing 16 that extends over the inner housing 50 and the distal end portions 40 of the latch arms 36. The boot 18 is coupled to the outer housing 16 and comprises a substrate 56 and a strain relief component 58, and therefore may also be referred to as a “strain relief assembly”. In alternative embodiments, the boot 18 may be formed from a single component.

Embodiments are also possible where the boot 18 and outer housing 16 are integrally-formed components. FIG. 2 also illustrates the connector 10 further including a transition tube 60 and a crimp band 62, which are used to attach the cable 12 (FIG. 1) to the inner housing 50.

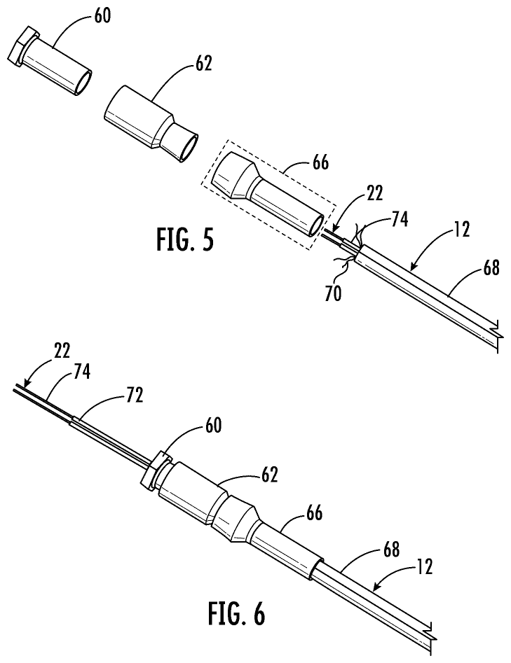

In particular, FIG. 5 illustrates the transition tube 60 and crimp band 62 next to a heat shrink tube 66 and the cable 12. The dashed lines around the heat shrink tube 66 schematically represent an initial, unshrunk configuration that the heat shrink tube 66 may have. The cable 12 is schematically illustrated having an outer cable jacket 68 that carries two optical fibers 22 and strength members 70, which may be in the form of aramid yarn.

The cable jacket 68 may be cut differently than as shown so that a longer length of the optical fibers 22 extends past an end of the cable jacket 68. The strength members 70 may also be cut so that the strength members 70 extend a desired length beyond the cable jacket 68.

To assemble the components, the heat shrink tube 66 and crimp band 62 may be slid onto the cable 12 and moved away from the end of the cable jacket 68. The transition tube 60 may then be advanced over the optical fibers 22 to be adjacent the end of the cable jacket 68, at which point the strength members 70 are flared over a rear portion of the transition tube 60. The previously positioned crimp band 62 is then slid forward from the cable jacket 68 to extend over the rear portion of the transition tube 60 and the flared-out strength members 70, at which point the crimp band 62 is crimped onto the transition tube 60 to secure the strength members 70 (and, therefore, the cable 12) to the transition tube 60. Finally, the previously positioned heat shrink tube 66 is then slid forward over at least a portion of the crimp band 62 and an end portion of the cable jacket 68. The heat shrink tube 66 is then activated (i.e., heated) to shrink down over the interface between the cable 12 and connector components, resulting in the arrangement shown in FIG. 6. Finally, end sections of the optical fibers 22 may then be stripped of coating material 72 over a desired length such that the end sections comprise “bare glass” or “exposed glass” sections 74. The order in which the various steps mentioned above occur may vary depending on the particular embodiment/application.

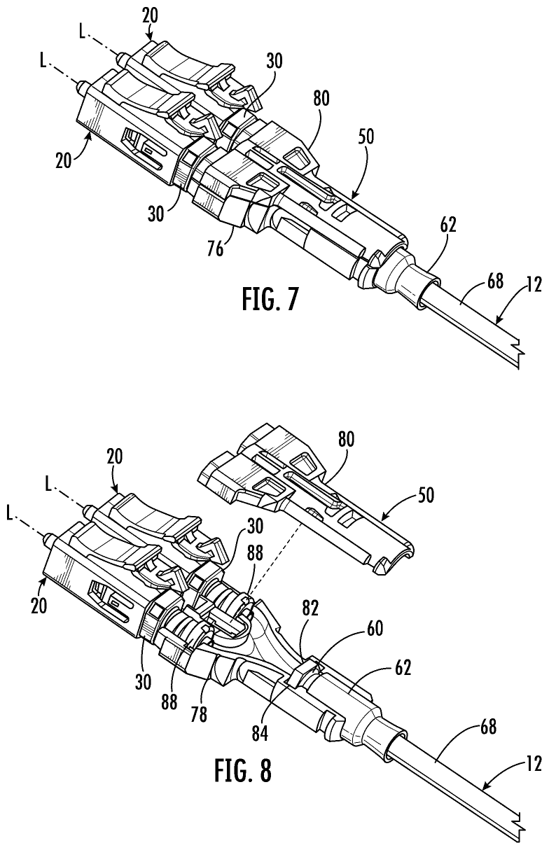

The first and second connector sub-assemblies 20 (FIGS. 2 and 4) may be installed on the optical fibers 22 after the cable 12 is prepared in the manner described above. Then, both the first and second connector sub-assemblies 20 and the transition tube 60 may be assembled with the inner housing 50. For example, FIGS. 7 and 8 illustrate how the transition tube 60 can couple to the inner housing 50, which in turn couples the cable 12 to the connector 10. The inner housing 50 in the embodiment shown has a two-piece construction, comprising a base 78 and a lid 80 (also referred to as a cover) that are coupled together. A rear portion of the base 78 receives both the transition tube 60 and a portion of the crimp band 62. The transition tube 60 in the embodiment shown is generally cylindrical with a flange 82 defined at one end. The flange 82 is received in a cutout or slot 84 defined in the base 78 to retain the transition tube 60 in the rear portion of the inner housing 50. The lid 80 of the inner housing 50 may also have a cutout or slot to receive the flange 82 when the lid 80 is coupled to the base 78. The coupling between the base 78 and the lid 80 may be achieved through any technique, including but not limited to using a snap-fit, an interference fit, and/or adhesive.

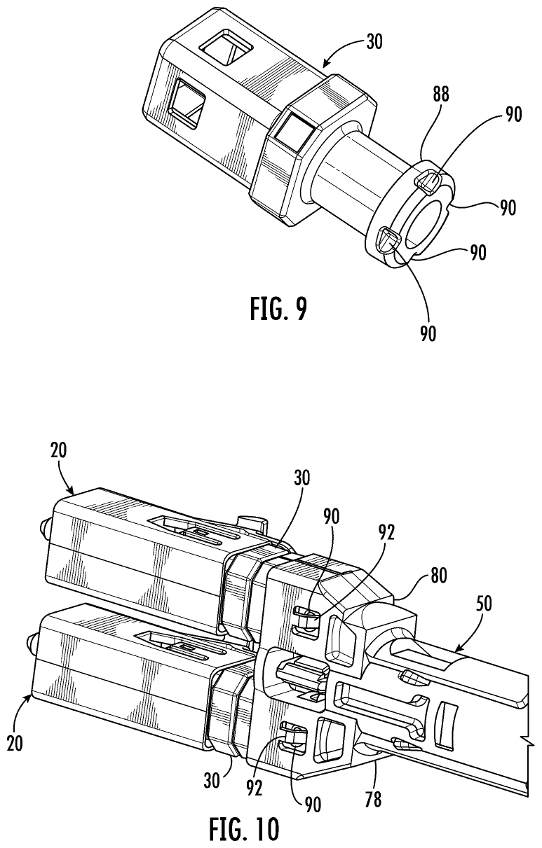

Still referring to FIGS. 7 and 8, a front portion of the base 78 holds the rear stopper components 30 of the first and second connector sub-assemblies 20. The inner housing 50 includes an inner cavity 86, which is largely defined by the base 78 and which allows the optical fibers 22 (not shown in FIG. 8 to simplify the drawing) to extend between the transition tube 60 and the first and second connector sub-assemblies 20. One of the optical fibers 22 extends to the first connector sub-assembly 20, and the other optical fiber 22 extends to the second connector sub-assembly 20. The rear stopper components 30 of the connector sub-assemblies 20 each include a radial flange 88 that allows the inner housing 50 to retain the rear stopper components 30 therein. In other words, the rear stopper components 30 cannot be pulled axially out of the inner housing 50 when the inner housing 50 is assembled. However, the base 78 and the lid 80 are shaped to still allow rotation of the rear stopper components 30 relative to the inner housing 50, which results in the entire connector sub-assemblies 20 rotating relative to the inner housing 50 as well. Each connector sub-assembly 20 can therefore rotate about its respective connector sub-assembly axis L without being removed from the inner housing 50. Optionally, features can be provided to help guide such rotation. This can be better understood with additional reference to FIGS. 9 and 10.

FIG. 9 illustrates how in the embodiment shown, the radial flange 88 of the rear stopper component 30 is generally circular and located on a cylindrical portion of the rear stopper component 30. The radial flange 88 includes rotation locking features in the form of notches 90 at different circumferential locations about the connector sub-assembly axis L.

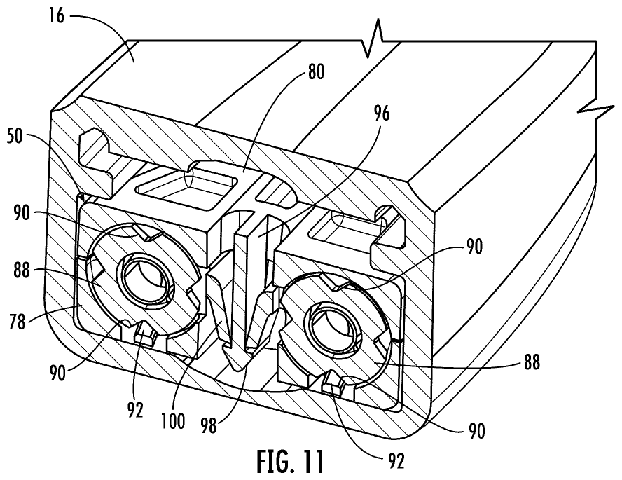

For each rear stopper component 30, the inner housing 50 includes complementary locking features defined by the base 78 and/or the lid 80. More specifically, and with additional reference to FIGS. 10 and 11 (the latter also showing the outer housing 16), the base 78 in the embodiment shown includes two flexible extension members in the form of arms or tabs 92, one for each rear stopper component 30. The flexible tabs 92 are designed to engage one of the notches 90 when the rear stopper components 30 rotate so that there is a snap fit between the rear stopper components 30 and the inner housing 50. In other words, the flexible tabs 92 are configured to be received in one of the notches 90, and there is interference between the flexible tabs 92 and rear stopper components 30 that must be overcome for the notches 90 to rotate away from the flexible tabs 92. Each rear stopper component 30 can be rotated to overcome the snap fit, but eventually the rotation results in a different notch 90 becoming engaged with the corresponding flexible tab 92. The rear stopper components 30 are then held in that rotational position unless additional force is applied to overcome the snap fit again. As can be appreciated, the different circumferential positions of the notches 90 correspond to different rotational positions to which the rear stopper components 30 can be indexed and releasably held by the inner housing 50. This indexing applies to the connector sub-assemblies 20 in general since the connector sub-assemblies 20 are designed to rotate as respective units. That is, when one of the rear stopper components 30 rotates about the corresponding connector sub-assembly axis L, the other components of that connector sub-assembly 20 also rotate about the connector sub-assembly axis L. In alternative embodiments, only some of the other components of the connector sub-assembly 20 may rotate together with the rear stopper component 30. Embodiments are also possible where the rear stopper components 30 are not configured to rotate relative to the inner housing 50, but the connector bodies 28 are still configured to rotate about the corresponding connector sub-assembly axis L.

Although the embodiment shown illustrates each rear stopper component 30 as having four notches 90 on the radial flange 88, with the notches 90 approximately 90 degrees apart from each other about the corresponding connector sub-assembly axis L, in alternative embodiments there may be fewer or more notches 90. There are particular advantages to having two notches 90 that are 180 degrees apart from each other about the connector sub-assembly axis L for reasons discussed below, even if additional notches 90 are provided. In alternative embodiments, the radial flange 88 may also have non-round configuration, such as a hexagonal or square configuration. Similarly, although the embodiment shown only illustrates the base 78 as including the flexible tabs 92 for engaging the notches 90, in some embodiments the lid 80 may include flexible extension members to provide additional or alternative engagement with the notches 90. Embodiments are also possible using different types of complementary locking features that provide releasable engagement to hold the connector sub-assemblies 20 in different rotational positions about the connector sub-assembly axes L. The notches 90 and flexible tabs 92 are merely one example of complementary locking features, and this disclosure should not be limited to such structures since alternatives are readily apparent to those skilled in this technical field.

FIG. 11 further illustrates how the base 78 and lid 80 may be coupled together, which was briefly described above. In particular, FIG. 11 is a cross-sectional perspective view showing how the lid 80 may include an inner projection 96 that terminates in a catch 98. The base 78 in this embodiment defines receiving area or an inner slot 100 for the projection 96, with the slot 100 having a bottom opening that the catch 98 passes though. As can be appreciated, when the projection 96 is inserted into the slot 100, the catch 98 may be forced through the bottom opening, which is configured to temporarily expand to allow such passing through. The bottom opening then returns to its non-expanded state when the catch 98 passes through, and the catch 98 is shaped to help prevent the reverse movement. Such an arrangement is merely one example of how the base 78 and lid 80 may be coupled together. As mentioned above, other arrangements are possible for different embodiments.

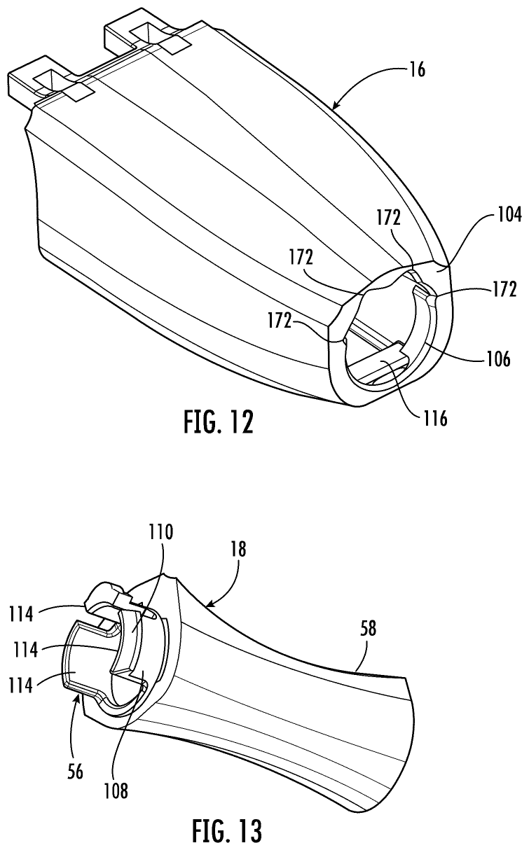

Referring back to FIGS. 1 and 2, the only other components not yet described in more detail are the outer housing 16 and boot 18. In general, both the outer housing 16 and boot 18 may be placed over the cable 12 before assembling the inner housing 50. Once the inner housing 50 is assembled, the outer housing 16 may then be moved forward to extend over the inner housing 50 and the distal end portions 40 of the latch arms 36. The boot 18 is coupled to the outer housing 16 in a manner so that the boot 18 is configured to move with the outer housing 16 along the longitudinal axis A. That is, the boot 18 is axially coupled to the outer housing 16. FIGS. 12-14 illustrate this aspect in further detail.

In particular, FIGS. 12 and 13 respectively illustrate the outer housing 16 and boot 18 in isolation. The outer housing 16 includes a rear wall or side 104 that defines an opening 106 for receiving a portion of the boot 18. In FIG. 13, the boot 18 is shown with the substrate 56 and the strain relief component 58 coupled together. The substrate 56 and strain relief component 58 may be formed from respective first and second materials, with the second material being less rigid than the first material. For example, in some embodiments the second material may be an elastomer, such as thermoplastic polyurethane, and the first material may be something having a higher modulus of elasticity and/or shear modulus, such as a polycarbonate or metal. The strain relief component 58 may be overmolded onto a portion of the substrate 56 or coupled to a portion of the substrate 56 by a friction/interference fit so that the substrate 56 and strain relief component 58 together function as an assembled unit. Similar two-piece strain relief assembly designs and associated advantages are disclosed in U.S. Pat. Nos. 9,551,842 and 10,261,268, the disclosure of such strain relief assembly designs being incorporated herein by reference.

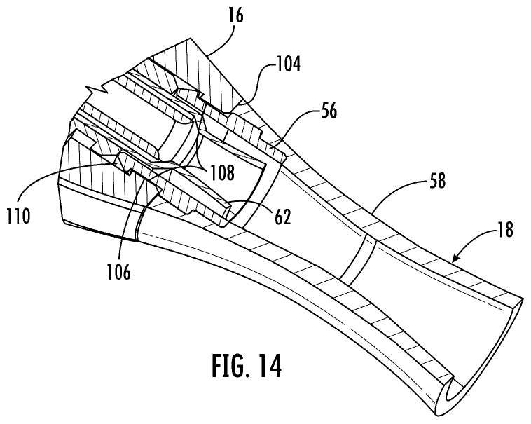

The substrate 56 is shaped so that a circumferential channel 108 is defined between portions of the substrate 56 and an end of the strain relief component 58. As shown in FIG. 14, the boot 18 can be assembled with the outer housing 16 so that the rear wall 104 of the outer housing 16 resides in the channel 108. In particular, an end portion of the substrate 56 extends through the opening 106 in the rear wall 104 of the outer housing 16 and defines a flange 110. The portion of the rear wall 104 that defines the opening 106 becomes sandwiched between the flange 110 of the substrate 56 and the end of the strain relief component 58 when coupling the components together. Such an arrangement prevents or substantially constrains relative axial movement between the boot 18 and the outer housing 16. Thus, the boot 18 and outer housing 16 are coupled in the axial direction (“axially coupled”).

Referring back to FIGS. 12 and 13, in the embodiment shown the end portion of the substrate 56 is defined by several arc-shaped segments 114. The segmented arrangement may facilitate inserting the end portion of the substrate 56 through the opening 106 in the outer housing 16, as the segments 114 may flex radially inward when encountering interference from the opening 106 and then flex back outwards upon clearing the interference. As shown in FIG. 12, the opening 106 may be shaped to allow limited relative rotation between the substrate 56 and the outer housing 16. For example, the boot 18 may be rotated about the longitudinal axis A relative to the outer housing 16 until one of the arc-shaped segments 114 of the substrate 56 contacts a flat 116 defined in the outer housing 16 (e.g., the flat 116 may be partially or fully defined in the opening 106). Further rotating the boot 18 in the same direction then results in the outer housing 16 rotating together with the boot 18 in that direction. In alternative embodiments, the opening 106 may be designed to prevent or substantially constrain all relative rotation between the boot 18 and the outer housing 16. In other words, the boot 18 may not be able to rotate about the longitudinal axis A relative to the outer housing 16. The boot 18 and the outer housing 16 may instead be intended to always rotate together in such embodiments.

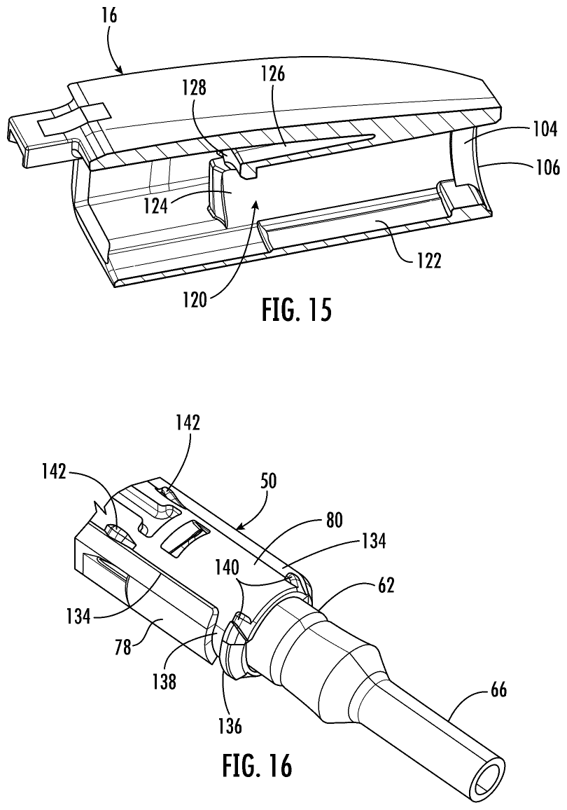

As mentioned above, the outer housing 16 and boot 18 may be placed over the cable 12 before assembling the inner housing 50 and then moved forward after assembling the inner housing 50. FIG. 15 illustrates one example of how internal structure of the outer housing 16 may be configured to interact with a rear portion of the inner housing 50, which in turn is illustrated in FIG. 16. As shown in FIG. 15, the outer housing 16 includes a receiving area 120 adjacent the opening 106 in the rear wall 104, with the receiving area 120 being defined by a bottom wall 122, two arcuate inner sidewalls 124 (only one being visible in FIG. 15 due to the cross-section), and an inner top wall 126. The receiving area 120 has a shape that generally corresponds to the profile of the rear portion of the inner housing 50. For example, the bottom wall 122 is shaped to correspond to a bottom of the inner housing 50 that is defined by the base 78. The arcuate inner sidewalls 124 are shaped to correspond to arcuate sides of the base 78 and the lid 80. And the inner top wall 126 is shaped to extend over a top of the inner housing 50 that is defined by the lid 80. The inner top wall 126 extends axially inward from the opening 106 and terminates with a radial flange 128, whose purpose will be described below in connection with use/operation of the connector 10.

As shown in FIG. 16, the rear portion of the inner housing 50 is generally cylindrical, but has a top and bottom that is truncated in the sense that such rear portion has a smaller radial profile/footprint at its top and bottom compared to its arcuate sides. The top and bottom remain curved like the arcuate sides but at a smaller radius from the longitudinal axis A. In alternative embodiments, however, the top and bottom of the rear portion of the inner housing 50 may be generally flat or otherwise include a flat section between the arcuate sides. Regardless of the exact configuration of the top and bottom of the inner housing 50, the lid 80 is shaped to define axially-extending ridges 134 between the top and the arcuate sides of the inner housing 50. The ridges 134 terminate at or near a rear flange 136 or rear stopping feature 140 of the inner housing 50. More specifically, one of the ridges 134 terminates at a circumferentially-extending groove 138 defined in one of the arcuate sides of the rear portion of the inner housing 50, adjacent the rear flange 136 and a first rear stopping feature 140 that may be a continuation of the rear flange 136 (but with the first rear stopping feature 302 having a different shape than a neighboring portion of the rear flange 136). Both the lid 80 and base 78 are configured to define respective portions of the groove 138 and rear flange 136. The other ridge 134 (far side from view in FIG. 16) terminates at a second rear stopping feature 140 that is circumferentially aligned with the first rear stopping feature 140; the groove 138 is not provided on the other arcuate side of the rear portion of the inner housing 50 in the embodiment shown. Although FIG. 16 only illustrates the lid 80 as including the ridges 134, the base 78 has a similar configuration on an opposite side of the inner housing 50. Thus, the base 78 includes similar ridges 134 adjacent the bottom of the rear portion of the inner housing 50. In alternative embodiments, the top and bottom of the rear portion of the inner housing 50 may each only include a single ridge 134 (e.g., the ridge 134 that terminates at the groove 138).

The first and second stopping features 140 each have a ramp-like configuration from a back end of the inner housing 50. This can help facilitate assembly of the outer housing 16 relative to the inner housing 50. In this regard and referring collectively to FIGS. 15 and 16, the rear portion of the of the inner housing 50 is configured to be positioned in the receiving area 120 of the outer housing 16. When the outer housing 16 is moved forward over the rear portion of the inner housing 50 during assembly, the rear portion of the inner housing 50 gets positioned between the arcuate inner sidewalls 124 of the receiving area 120. However, the radial flange 128 on the inner top wall 126 contacts the first and second stopping features 140 due to interference that is built into the design of the components. The ramp-like configuration of the stopping features 140 helps direct the inner top wall 126 to flex radially outward so that the radial flange 128 can travel over the stopping features 140. Eventually the radial flange 128 clears the stopping features 140, and the outer housing 16 can continue to be advanced axially so that the rear portion of the inner housing 50 enters further into the receiving area 120. During such advancing of the outer housing 16, the radial flange 128 encounters resistance features 142, which in the embodiment shown are bumps on the top of the rear portion of the inner housing 50. However, by applying sufficing to the outer housing 16, the radial flange 128 can travel over the resistance features 142 similar to how the radial flange 128 is configured to travel over the stopping features 140.

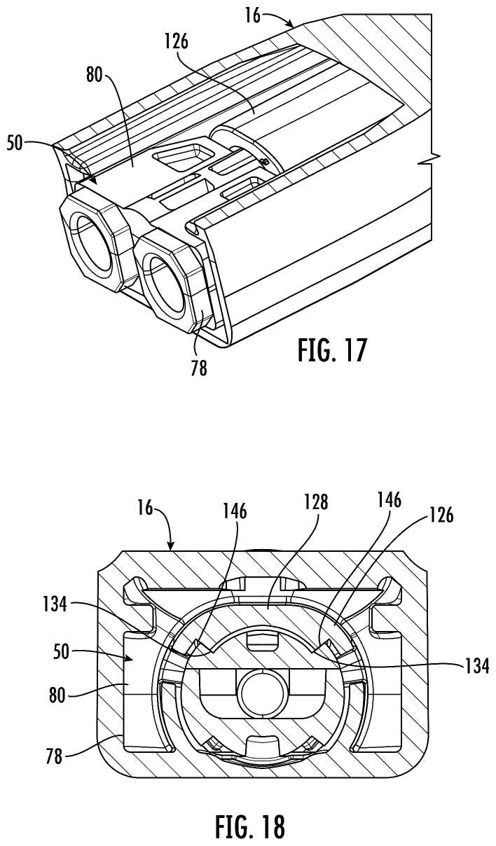

FIG. 17 illustrates the outer housing 16 and inner housing 50 when these components are fully assembled. As can be appreciated, the components are designed in a way that limits how far the outer housing 16 may be advanced over the inner housing 50. In the embodiment shown, the arcuate inner sidewalls 124 (FIG. 15) and inner top wall 126 eventually contact a front portion of the inner housing 50, but other configurations for limiting travel of the outer housing 16 are also possible. As shown in FIG. 18, the radial flange 128 on the inner top wall 126 is disposed on or adjacent the top of the rear portion of the inner housing 50. The inner top wall 126 is also shaped to have side edges 146 that each face a respective one of the ridges 134 on the rear portion of the inner housing 50. Such an arrangement constrains relative rotation between the components. In essence, the ridges 134 function as anti-rotation features that block rotation of the radial flange 128 and, therefore, the inner top wall 126 and the outer housing 16 in general. Both the ridges 134 and side edges 146 extend in a radial direction in the embodiment shown, and specifically in a radial plane that extends through the longitudinal axis A (FIGS. 1 and 2). This results in a contact angle between the ridges 134 and side edges 146 being zero such that a contact force that is created from torque applied to the outer housing 16 (attempted rotation) is maximized. Thus, such an arrangement can more effectively prevent relative rotation compared to configurations where the ridges 134 and/or the side edges 146 extend at an angle relative to a radial plane through the longitudinal axis A, as contact forces from the same amount of torque would be less in such embodiments. Nevertheless, such latter embodiments remain possible and within the scope of this disclosure.

FIGS. 3A and 3B illustrate the fully assembled connector 10, with the outer housing 16 extending over the inner housing 50 and the distal end portions 40 of the latch arms 36.

The assembly process may involve a user depressing the latch arms 36 when moving the outer housing 16 forward to allow the outer housing 16 to travel over the distal end portions 40 of the latch arms 36. However, this is merely for assembly of the connector 10 such that the latch arms 36 may be allowed to return to an unflexed state by the time the outer housing 16 has reach its forward, installed position.

Now that the general arrangement of the connector 10 has been described, reference can be made to FIGS. 19 and 20 to understand aspects of how the connector 10 operates. In particular, FIGS. 19 and 20 illustrate how the boot 18 and outer housing 16 may be used to remove the connector 10 from the adapter 210. The adapter 210 is known as a senior adapter and merely one example of a receptacle into which the connector 10 may be plugged. Those skilled in optical connectivity will appreciate that other devices, such as transceivers and other equipment, may define similar receptacle interfaces such that the discussion below may both types of receptacles (senior adapters and active device receptacles) for the connector 10. Indeed, the geometry aspects pertinent to the illustrated embodiment remain the same for senior adapter interfaces and active device receptacle interfaces in standards IEC 61754-20 and TIA/EIA 604-10. In FIG. 19, the connector 10 is shown as being mated to the adapter 210. The latching features 42 (FIGS. 2 and 3A) of the connector sub-assemblies 20 engage corresponding latching features 212 of the adapter 210 to secure the connector 10 to the adapter 210. The distal end portions 40 of the latch arms 36 are covered by extension members 150 of the outer housing 16. The extension members 150 project into ports 214 of the adapter 210 that receive the connector sub-assemblies 20 to extend over the distal end portions 40. The extension members 150 each include an opening 152 that receives the distal end portions 40 of the latch arms 36 so that an inner wall 154 (FIG. 3B) of the opening 152 is positioned in front of and axially aligned with the actuation surface 44 of the corresponding latch arm 36.

FIG. 20 illustrates the connector 10 after moving the boot 18 and the outer housing 16 together rearward. As mentioned above, either the boot 18 or the outer housing 16 may be pulled by a user. Pulling either component moves both boot 18 and the outer housing 16 axially relative to the remainder of the connector 10. Such movement causes the extension members 150 of the outer housing 16 to move along the actuation surfaces 44 of the latch arms 36, and more specifically, causes the inner wall 154 (FIG. 3B) of the openings 152 to contact and slide along the actuation surfaces 44. The latch arms 36 flex toward the respective connector sub-assembly axes L (FIG. 4) as the extension members 150 travel along the actuation surfaces 44, resulting in the latch arms 36 being depressed (i.e., pressed downward). Before the openings 152 of the extension members 150 clear the actuation surfaces 44, the latch arms 36 move sufficiently downward so that the latching features 42 (FIGS. 2 and 3A) of the latch arms 36 no longer engage the latching features 212 of the adapter 210. Thus, the latching/coupling mechanism between the connector 10 and the adapter 210 is released. If a user continues to pull the boot 18 or the outer housing 16 rearward, friction between the actuation surfaces 44 and extension members 150 may still be sufficient to retain the extension members 150 on the distal end portions 40 of the latch arms 36. Alternatively or additionally, the resistance features 142 (FIG. 16) on the inner housing 50 may be positioned to interfere with rearward movement of the outer housing 16 that would otherwise cause the extension members 150 to travel all the way over the distal end portions 40 of the latch arms 36. Thus, the outer housing 16 may remain extending over the distal end portions 40 of the latch arms 36, and the connector 10 can move as a unit away from the adapter 210.

Removing the connector 10 from the adapter 210 may result in the latch arms 36 flexing back away from the connector bodies 28. For example, the internal spring force of the latch arms 36 may be greater than friction between the extension members 150 and the actuation surfaces 44. Once the latching features 42 of the latch arms 36 clear the latching features 212 of the adapter 210 when the connector 10 moves rearward relative to the adapter 210, the internal spring force causes the latch arms 36 to move back to an unflexed state, which in turn causes the extension members 150 to slide back down the actuation surfaces 44. Thus, the outer housing 16 and the boot 18 may move slightly forward relative to the remainder of the connector 10 to have a configuration similar what is shown in FIG. 3A. In other embodiments, the latch arms 36 may remain depressed by the extension members 150 after removing the connector 10 from the adapter 210.

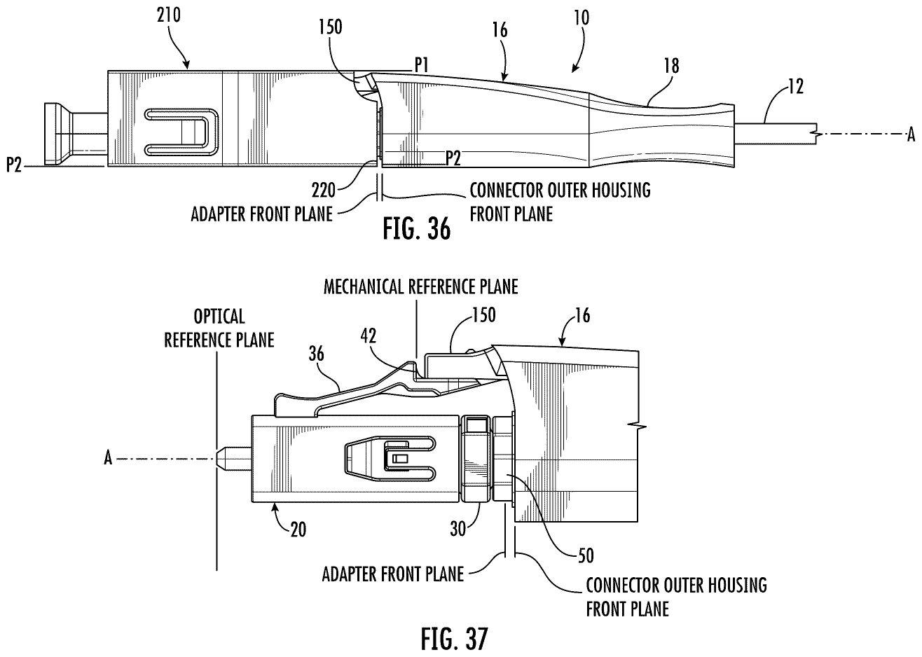

FIGS. 19 and 20 illustrate the inner housing 50 extending into the ports 214 of the adapter 210 when the connector 10 is mated with the adapter 210. FIG. 36 illustrates this aspect as well. The inner housing 50 extends past an adapter front wall 220 that defines a front plane of the adapter 210 (labeled as “ADAPTER FRONT PLANE”) and into the ports 214 so that a short length of the front portion of the inner housing 50 extends adjacent to sidewalls of the adapter 210. If the connector 10 experiences side loads when mated with the adapter 210, stresses are shared between the inner housing 50 (and specifically the base 78 and lid 80 in the illustrated embodiment) and the rear stopper components 30 (or whichever structure defines the rear portions of the connector sub-assemblies 20 in alternative embodiments). The distribution of stresses differs from conventional designs, which do not include an inner housing that holds connector sub-assemblies being configured to extend into ports of an adapter, and which as a result can lead to stresses from side loads being concentrated on the rear stopper components 30 adjacent the adapter front wall 220. The compact nature of the connector sub-assemblies 20, and the geometric relation between the adapter 210 and components of the connector 10 to provide the arrangement shown, will be discussed further below after first describing other aspects of this disclosure.

One of the other aspects relates to reversing polarity. When the connector 10 is not mated to an adapter or other receptacle, the polarity of the connector 10 can be reversed to switch which connector sub-assembly 20 is associated with which side of the connector 10 (e.g., switched from an A-B configuration to a B-A configuration). The process for reversing polarity involves rotating the connector sub-assemblies 20 about their respective connector sub-assembly axes L. During normal use of the connector 10, the outer housing 16 prevents such rotation. In other words, even though the connector sub-assemblies 20 may be held in the front portion of the inner housing 50 in a manner that still allows the connector sub-assemblies 20 to rotate relative to the inner housing 50 about their respective connector sub-assembly axes L, the outer housing 16 may prevent such rotation by way of the extension members 150 engaging the distal end portions 40 of the latch arms 36. In some embodiments, it may be possible for a user to press the latch arm 36 of a respective connector sub-assembly 20 further toward the main portion of the connector body 28 to release the engagement with the corresponding extension member 150, and then rotate that connector sub-assembly 20 relative to the inner housing 50 while continuing to press the latch arm 36 down. However, such steps may be challenging for the user given the size of optical connectors (including the connector 10).

A more user-friendly approach to enable rotation of the connector sub-assemblies 20 is to instead move the outer housing 16 rearward away from connector sub-assemblies 20, such as moving the outer housing 16 so that the extension members 150 slide completely over the actuation surfaces 44 and eventually move completely off the distal end portions 40 of the latch arms 36. Various connector 10 designs are known where an outer housing 16 is moved rearward from a remainder of the connector 10 to assist with reversing polarity. The designs involve pushing an outer housing back onto a cable, rotating the outer housing 180 degrees about the cable, and then moving the outer housing back onto the connector. There remain challenges with such designs, such as the outer housing sliding far back onto the cable away from a user. The outer housing may then be difficult or cumbersome for the user retrieve, especially if the cable is installed in an environment with many other cables. A user may also be uncertain if he or she has correctly rotated the outer housing before attempting to move the outer housing back onto the remainder of the connector. The outer housing having an incorrect rotational orientation without the user knowing so can lead to frustration, with the user being prevented (unexpectedly) from moving the outer housing to a proper forward position relative to the remainder of the connector. The user may have to attempt the movement several times, slightly adjusting the rotational orientation of the outer housing each time until the desired forward movement can be achieved.

Designs are also known that include a removable outer housing or clip instead of a retractable outer housing. Reversing polarity for such designs requires removing the clip from one side of the connector and then attaching the clip to an opposite side of the connector. However, there is the potential for a user to drop and misplace the clip when the user removes the clip, and the user may not be sure when to re-attach the clip to the connector during the reverse polarity process.

Advantageously, the present disclosure provides features to address the drawbacks of known designs that involve moving an outer housing or clip away from connector sub-assemblies during a polarity reversal process. The features relate to interaction between the rear portion of the inner housing 50 and the outer housing 16 when the outer housing 16 is moved rearward. Referring back to FIGS. 15-18, and as mentioned above, the radial flange 128 of the inner top wall 126 of the outer housing 16 includes side edges 146 confronting the ridges 134 on the inner housing 50. If the outer housing 16 is moved rearward relative to the inner housing 50, the radial flange 128 may first encounter interference from the resistance features 142. However, the resistance features 142 are shaped in a way that still allows the interference to be overcome with a slight increase in pulling force applied to the outer housing 16. In other words, as was the case with installing the outer housing 16, the radial flange 128 is able to move over the resistance features 142 upon application of sufficient force. The resistance features 142 provide a user with tactile feedback to ensure the movement is intentional. In other words, the resistance features 142 help prevent unintentional movement of the outer housing 16 to its rear position.

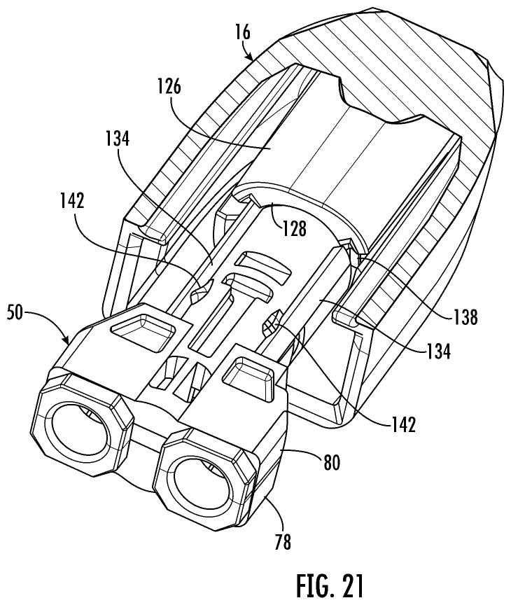

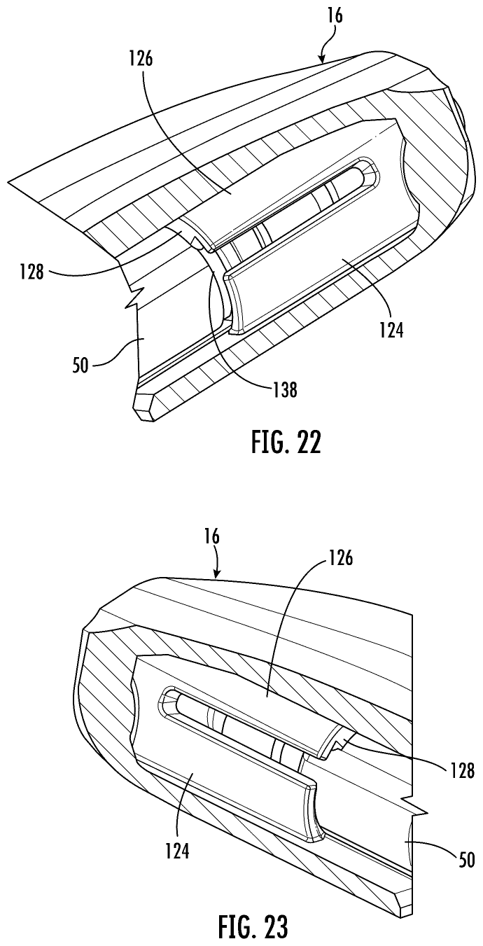

Continued rearward movement of the outer housing 16 after the radial flange 128 moves over the resistance features 142 eventually results in the radial flange 128 coming into contact with the stopping features 140 of the inner housing 50. Such an arrangement is shown in FIGS. 21-23, with FIGS. 22 and 23 being views from opposite sides for the connector 10 with portions of the outer housing 16 cut-away to see the interaction between the radial flange 128 and rear portion of the inner housing 50. The stopping features 140 (FIG. 16), which can be considered as portions of the rear flange 136, block the radial flange 128 from moving further rearward relative to the inner housing 50. Unlike the resistance features 142, the stopping features 140 are shaped with the intent of preventing the radial flange 128 from moving over them during expected use of the connector 10. Thus, the outer housing 16 is retained on the inner housing 50 even when the outer housing 16 is moved back from the connector sub-assemblies 20. The position of the outer housing 16 shown in FIGS. 21-23 is referred to in this disclosure as a “rear position” of the outer housing 16. In this rear position, the radial flange 128 is aligned with the groove 138 of the inner housing 50 for reasons that will be discussed below.

The position of the outer housing 16 when the connector 10 is in use for normal mating, such as shown in FIGS. 3A and 19, is referred to in this disclosure as a “forward position” of the outer housing 16. Thus, the outer housing 16 is movable along the longitudinal axis A from this forward position to the rear position mentioned above. The outer housing 16 can also move in a reverse manner from the rear position to the forward position. FIGS. 3B and 4 illustrate how the distal end portions 40 of the latch arms 36 include rearwardly-facing inclined surfaces 144 to assist with such reverse movement. The inclined surfaces 144 come into contact with the extension members 150 of the outer housing 16 when the outer housing 16 is moved toward its forward position. Continued forward movement of the outer housing 16 results in the extension members 150 moving along the inclined surfaces 144, with the latch arms 36 each flexing towards the associated connector sub-assembly axis L to accommodate such movement. Eventually the extension members 150 extend all the way over the inclined surfaces 144 and begin to slide along the actuation surfaces 44 until the outer housing 16 reaches its forward position.

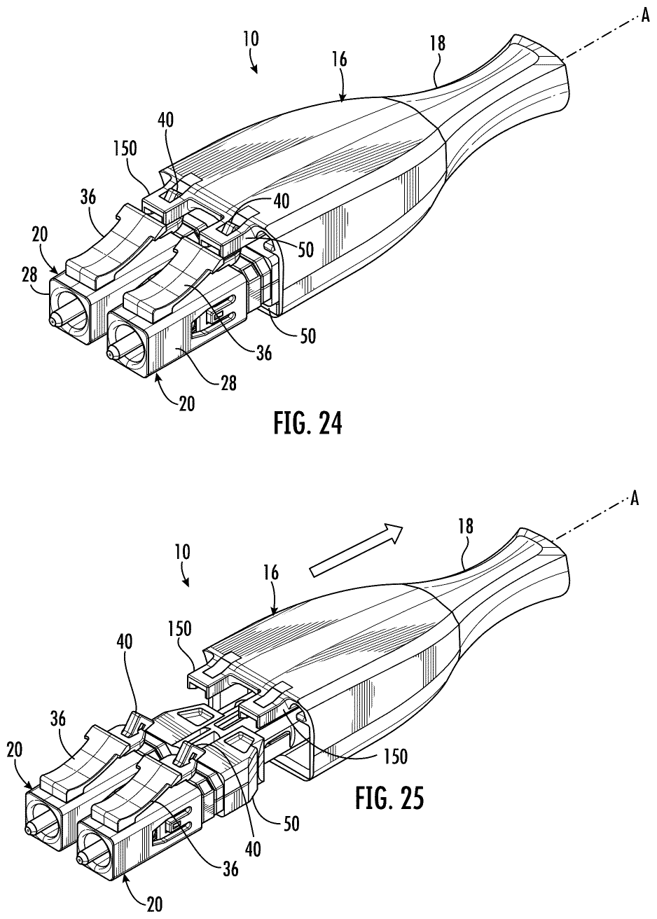

Thus, the outer housing 16 is movable along the longitudinal axis A between its forward position and rear position. Because the boot 18 is coupled to the outer housing 16 in the axial direction, the boot 18 is movable together with the outer housing 16 between two corresponding positions. With this in mind, an example process of reversing polarity of the connector 10 will now be described with reference to FIGS. 24-31. As mentioned above, the outer housing 16 normally prevents each connector sub-assembly 20 from rotating any significant amount about its associated connector sub-assembly axis L. This is the arrangement shown in FIG. 24, with the outer housing 16 in its forward position and the extension members 150 arranged over the distal end portions 40 of the latch arms 36.

Because the connector 10 is not inserted into a receptacle, a user can hold the connector bodies 28 with one hand and pull the boot 18 and/or the outer housing 16 axially with their other hand. The outer housing 16 then moves off and away from the latch arms 36 of the connector sub-assemblies 20 in the manner described above. Rearward movement of the outer housing 16 and boot 18 can continue until the outer housing 16 reaches its rear position, which is shown in FIG. 25. In this position, the stopping features 140 of the inner housing 50 prevent further relative movement of the outer housing 16 along the longitudinal axis A as noted above.

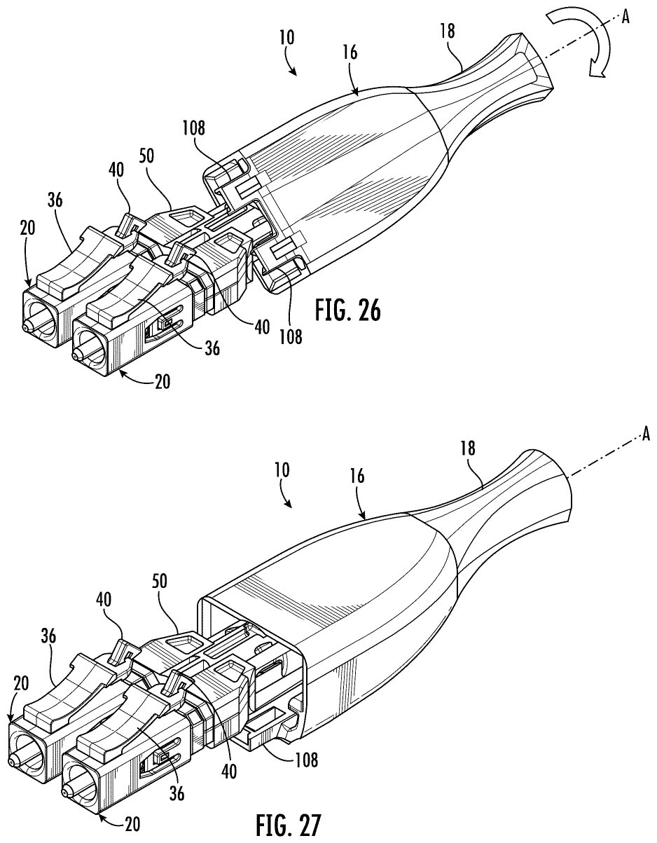

FIGS. 26 and 27 illustrate how the outer housing 16 and boot 18 may then be rotated 180 degrees about the longitudinal axis A to an opposite side of the connector 10. The rotation is possible because the radial flange 128 (FIGS. 21-23) of the outer housing 16 is aligned with circumferentially-extending groove 138 in the rear portion of the inner housing 50. Advantageously, the rear portion of the inner housing 50 is configured to prevent the rotation in other axial positions of the outer housing 16. A user is instead required to move the outer housing 16 to its rear position before such rotation can occur, which helps avoid doubt or confusion on when it is acceptable to perform this rotating step during the polarity reversal process. Additionally, by having the circumferentially-extending groove 138 on only one side of the inner housing 50, it is only possible to rotate the outer housing 16 in one direction about the longitudinal axis A. The user is effectively given only one option to complete the rotation to further eliminate doubt or confusion as to the process.

Although there are advantages of restricting rotation of the outer housing 16 until the outer housing 16 is in its rear position, alternative embodiments are possible without such a feature. For example, the outer housing 16 is considered to have an axial travel length between its forward and rearward positions. In some embodiments, the inner housing 50 may only be configured to restrict rotation of the outer housing 16 over a certain percentage of the axial travel length, such as 75%, 50%, etc. The groove 138 being much wider in the axial direction is one example of how this may be achieved. Embodiments are also possible where the inner housing 50 is not configured to restrict rotation of the outer housing 16 at all in one or both directions over the axial travel length, but is still configured to retain the outer housing 16 on at least the rear portion of the inner housing 50. The additional advantages for restricting rotation mentioned above, however, would not be present in such embodiments.

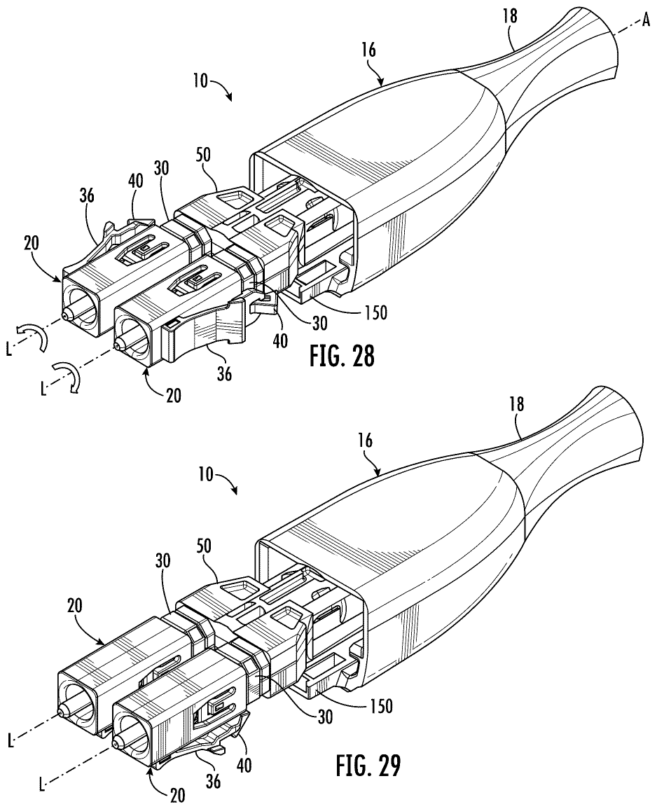

Returning to the connector 10 and now referring to FIGS. 28 and 29, the process for reversing polarity further includes rotating the connector sub-assemblies 20 about their respective longitudinal axes L by 180 degrees. As mentioned above, the inner housing 50 holds the rear stopper components 30 in a manner that allows such rotation without needing to remove the rear stopper components 30 from the inner housing 50. The rotation instead occurs in situ, i.e., with the connector sub-assemblies 20 remaining axially coupled to the inner housing 50. To initiate the rotation for each connector sub-assembly 20, and as discussed above in connection with FIGS. 9-11, a user must first apply sufficient force to overcome the engagement between one of the notches 90 on the corresponding rear stopper component 30 and the corresponding flexible tab 92 of the base 78. When a different notch 90 becomes radially aligned with the flexible tab 92, the resulting engagement between these complementary locking features provides new resistance that must be overcome to continue the rotation. Thus, the notches 90 can be used to help guide the connector sub-assemblies 20 into desired rotational positions relative to the inner housing 50. The connector sub-Attorney assemblies 20 are essentially snapped into place at the different rotational positions (i.e., indexed to the different rotational positions) due to the releasable engagement discussed above.

When rotating the connector sub-assemblies 20 in the directions indicated in FIG. 28, a user can feel when the next notch 90 on the respective rear stopper component 30 is engaged by the corresponding flexible tab 92. This occurs when the connector sub-assemblies 20 are rotated 90 degrees about their respective connector sub-assembly axes L. The user can clearly see that this is merely an intermediate position between opposite top and bottom sides of the connector 10, and can apply sufficient force to overcome the engagement to rotate the connector sub-assemblies 20 to their next indexed position. This occurs when the connector sub-assemblies 20 have been rotated an additional 90 degrees about their respective connector sub-assembly axes L, resulting in a total of 180 degrees of rotation from the initial position shown in FIGS. 24-27. The engagement between the notches 90 and the flexible tabs 92 in this rotational position provides the user with tactile feedback that the indexed position has been achieved. In some embodiments there may also be audible feedback as the flexible tabs 92 snap into the notches 90. As can be appreciated, by having the rear stopper components 30 with two notches 90 that are 180 degrees apart from each other, the connector sub-assemblies 20 have indexed rotational positions that are 180 degrees apart from each other. This can make it easy for a user to know when the connector sub-assemblies 20 have been properly rotated to an opposite top or bottom side of the connector 10.

Although FIGS. 28 and 29 illustrate the connector sub-assemblies 20 being rotated to orient the latch arms 36 on the opposite side of the connector 10 after rotating the outer housing 16 by 180 degrees, the steps may occur in a different order. For example, if desired, after moving the outer housing 16 rearward to no longer extend over the latch arms 36 (step shown in FIG. 25), the connector sub-assemblies 20 may be rotated 180 degrees in the manner described above before rotating the outer housing 16 by 180 degrees about the longitudinal axis A. Embodiments are also possible where the outer housing 16 is configured to allow the connector sub-assemblies 20 to rotate 180 degrees about the respective connector sub-assembly axis L when the outer housing 16 is in the forward position. In other words, some embodiments may not require the outer housing 16 to be move away from its forward position before rotating the connector sub-assemblies 20.

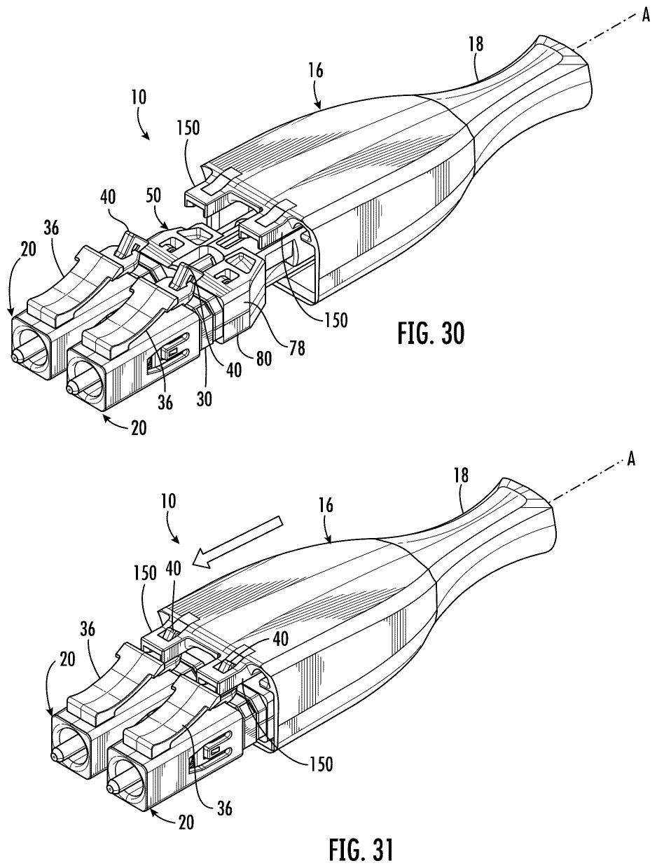

Regardless of the order in which components are rotated, after the outer housing 16 has been moved to its rear position and both the outer housing 16 and the connector sub-assemblies 20 have been rotated 180 degrees, the outer housing 16 can then be moved back to its forward position relative to the inner housing 50. Before doing so, and as shown in FIG. 30, a user may turn the entire cable assembly 14 over so that the connector 10 does not appear upside down. What was previously considered to be a bottom side of the connector 10 becomes a top side, and what was previously considered to be a top side of the connector 10 becomes a bottom side. To this end, the inner housing 50 is now oriented so that the base 78 is on the top side of the connector 10 and the lid 80 is on the bottom side of the connector 10. FIG. 31 then illustrates the outer housing 16 after moving the outer housing 16 back to its forward position. The order of these two steps associated with FIGS. 30 and 31 does not matter, as the end result is still what is shown in FIG. 31, which is similar to the arrangement shown in FIG. 3A except that the positions of the base 78 and the lid 80 of the inner housing 50 are reversed. The base 78 is now on the same side of the connector 10 as the latch arms 36 and extension members 150.

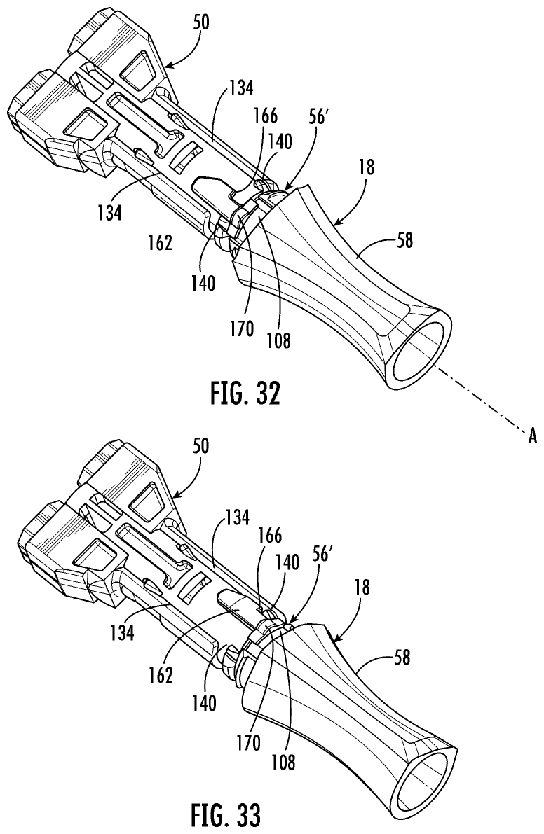

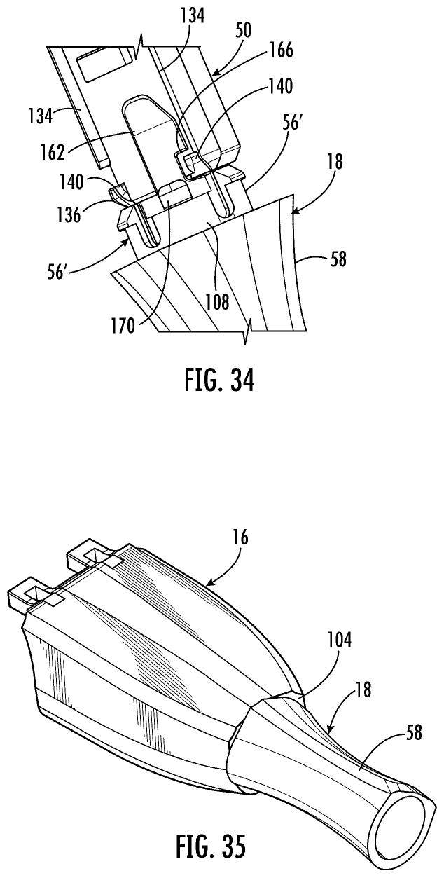

In some embodiments, the connector 10 may include features to lock the outer housing 16 and boot 18 axially so that they cannot be pulled rearward relative to the remainder of the connector 10 (including the inner housing 50), particularly when the outer housing 16 is in its forward position. Such a feature may be desirable to help prevent unintended actuation of the latch arms 36 and thereby help keep the connector 10 engaged with the latching features 212 of the adapter 210. For example, FIGS. 32-34 illustrate the connector 10 with the boot 18 having a modified substrate 56′ to provide this type of locking feature/functionality. The substrate 56′ is the same as the substrate 56 (FIGS. 2 and 13) with the exception of further including a locking arm 162 that extends over the rear portion of the inner housing 50 when the outer housing 16 is in the forward position. The locking arm 162 has a hook-like configuration to define a catch 166, which may also be referred to as a latch. The catch 166 is an overhang or lateral/circumferential extension of the locking arm 162, and FIGS. 33 and 34 illustrate the catch 166 positioned in the space in front of the second stopping feature 140 and adjacent the ridge 134 that is on the same side of the inner housing 50.

The boot 18 in this embodiment can rotate relative to outer housing 16 about the longitudinal axis A by some limited amount. The possibility of such limited relative rotation was mentioned above in connection with FIGS. 12-14 when first discussing the substrate 56.

The same principles apply with respect to the modified substrate 56′. The position of the boot 18 relative to the outer housing 16 and the inner housing 50 in FIGS. 33 and 34, with the catch 166 positioned in front of the second stopping feature 140, is referred to in this disclosure as a first rotational position or “locked” position. The boot 18 is prevented from being pulled back axially due to the second stopping feature 140 blocking the catch 166. In some embodiments there may some minimal axial movement from a forwardmost position of the boot 18 before the catch 166 contacts the second stopping feature 140, but not sufficient movement for the boot 18 to cause the outer housing 16 to depress the latch arms 36 (not shown in FIG. 33) of the connector sub-assemblies 20 in a way that would cause the connector 10 to disengage from a receptacle (e.g., the adapter 210).

FIG. 35 also illustrates the outer housing 16 and boot 18 when the boot 18 is in the locked position. In the embodiment shown, the boot 18 is designed so that the profile of the strain relief component 58 does not match the profile of the rear wall 104 of the outer housing 16 when the boot 18 is in the locked position, but does match the profile (see, e.g., FIGS. 1 and 3A) when the boot is in the unlocked position. The mismatch provides a user with an easy way to identify which rotational position is present, i.e., whether the boot 18 is in the locked or unlocked position.

As shown in FIG. 32, which omits the outer housing 16 for better visualization, the boot 18 can be rotated about the longitudinal axis A to a second rotational position, also referred to in this disclosure as an “unlocked” position. This rotation occurs relative to the outer housing 16 and relative to the inner housing 50 such that the catch 166 of the locking arm 162 is no longer axially aligned with the second stopping feature 140. In other words, the rotation causes the catch 166 to move away from the space in front the second stopping feature 140. The boot 18 is then free to move rearward, i.e., a user can pull the boot 18 back relative to the inner housing 50. As discussed above, the outer housing 16 moves axially with the boot 18 to eventually depress the latch arms 36 of the connector sub-assemblies 20. Furthermore, the boot 18 can be pulled back far enough so that the locking arm 162 does not extend over the rear portion of the inner housing 50 when the outer housing 16 is moved to its rear position. This allows the boot 18 to be rotated together with the outer housing 16 to the opposite side of the connector 10 when reversing polarity in the manner described above.

In some embodiments, the outer housing 16 and boot 18 may be designed with complementary snap-fit features that are configured to releasably engage each other when the boot 18 is in the locked and unlocked rotational positions. For example, FIGS. 32-34 illustrate how at least some of the arc-shaped segments 114 of the substrate 56′ may include radial bumps/protrusions 170 on the portion of the substrate 60′ that is received in the opening 106 (FIG. 12) of the outer housing 16. As shown in FIG. 12, the opening 106 may include one or more pockets or depressions 172 that become aligned with the radial protrusions 170 when the boot 18 is moved to its first and second rotational positions. The components may be designed to provide a slight interference fit so that the radial protrusions 170 snap into the depressions 172 or otherwise are held within the depressions 172. This releasable engagement helps prevent the boot 18 from being accidentally rotated out of the locked and unlocked rotational positions.

Having described different aspects and some optional features of the connector 10, the compact nature of the connector 10 that was discussed above with reference FIGS. 19 and 20 will now be revisited. In particular, as discussed above, the front portion of the inner housing 50 is configured to extend into the ports 214 of the adapter 210 when the connector 10 is mated with the adapter 210. The advantages of such an arrangement are also mentioned above and need not be repeated. Instead, the geometric relationship between the various components will be described in further detail with reference to FIGS. 19, 20, 36, and 37.

As annotated in FIGS. 19, 36, and 37, the adapter 210 and connector 10 define respective mechanical reference planes that are associated with the latching features 212 (FIG. 19) and latching features 42 (FIG. 3A), respectively. The mechanical reference planes are geometric datums upon which other dimensions relating to intermatability of the connector 10 and adapter 210 are based. Intermatability specifications for connectors and adapters are well-known in the field of optical connectivity. The intermatability specifications define the geometrical features required for connectors and receptacles (e.g., adapters) of the same type to ensure that connectors of the same type from different manufacturers can properly mate with receptacles of the same type from different manufacturers. Many intermatability specifications have been adopted in one or more industry standards. For example, the connector 10 and adapter 210 are mentioned above as being an LC-type connector and adapter. Intermatability standards for LC connectors and receptacles include IEC 61754-20 and TIA/EIA 604-10. Both standards define minimum required geometry for LC connectors and adapters in a similar manner, using the respective mechanical reference planes as datums for various dimensions.

In FIGS. 19, 20, 36, and 37, the adapter front wall 220 and associated adapter front plane is spaced from the mechanical reference plane of the adapter 210 by a certain distance in the axial direction. This distance will be referred to in this disclosure as a “first port distance”. The connector 10 is configured so that a front side of the inner housing 50 is spaced from the mechanical reference plane of the connector 10 by another distance in the axial direction. This latter distance is referred to in this disclosure as a “connector latching distance”. The first port distance is greater than the first connector latching distance. Thus, when the connector 10 is mated with the adapter 210, which results in alignment of the respective mechanical reference planes, the front side of the inner housing 50 is located within the ports 214, recessed from the adapter front wall 220. The front portion of the inner housing 50 extends some length within the ports 214 before extending past the adapter front wall 220 to account for the difference between the larger, first port distance and the smaller, first connector latching distance.

In the embodiment shown, the outer housing 16 is shaped to surround the inner housing 50 and have lateral sidewalls are located very close to the adapter front wall 220 when the connector 10 is mated with the adapter 210. For example, the lateral sidewalls of the outer housing 16 define a front plane of the portion of the outer housing 16 that is closest to the adapter front wall 220 (such plane being labeled in FIGS. 36 and 37 as “CONNECTOR OUTER HOUSING FRONT PLANE”). A bottom wall of the outer housing 16 also extends to that front plane in the embodiment shown. The front plane of the outer housing 16 is considered to be located at “a second connector latching distance” from the mechanical reference plane of the connector 10. The second connector latching distance may be close to the first port distance, such less than 20% greater, less than 15% greater, less than 10% greater, etc., so that the above-referenced connector outer housing front plane is close to the adapter front wall 220 when the connector 10 is mated with the adapter 210. Additionally, the top side of the outer housing 16 is configured to extend past the adapter front plane, with at least the extension members 150 of the outer housing 16 projecting into the ports 214. Such a configuration results in the outer housing 16 substantially or completely concealing the inner housing 50 when the connector 10 is mated with the adapter 210.

The concealing nature of the outer housing 16 can be better appreciated with reference back to FIG. 1. As shown in FIG. 1, when the connector 10 is mated with the adapter 210, only the outer housing 16 and boot 18 are presented to a user. Either or both of these components can be pulled by the user to remove the connector 10 from the adapter 210 since both the outer housing 16 and boot 18 are movable together along the longitudinal axis A in the manner discussed above. A user also need not worry about where to grab either of these components. Thus, a user is essentially presented with the option to pull anywhere on the connector 10 such that the connector 10 can be considered to have a “pull anywhere” configuration. No other component of the connector 10 is visible to the user in a substantial way, or at the very least able to be grasped/pulled by the user. In addition to having the benefit of avoiding user confusion or uncertainty, the pull anywhere configuration also has the benefit of being able to provide an aesthetically-pleasing design.

The concealing nature of the outer housing 16 may apply even when the front sides of the lateral sidewalls of the outer housing 16 are not entirely planar. As long as the front sides of the lateral sidewalls (i.e., all locations on the front side) are at a connector latching distance that is close to the first port distance (e.g., less than 20% greater, less than 15% greater, less than 10% greater, etc.), the concealed nature of the design remains. As a specific example, for an LC receptacle that is a senior adapter or active device interface, the distance from the optical reference plane of the LC receptacle to the mechanical reference plane may be about 10 mm, and the distance from the optical reference plane to the adapter front plane may be about 14.5 mm, which results in the adapter port distance being about 4.5 mm. The front sides of the lateral sidewalls may be spaced from the mechanical reference plane of the connector 10 by about 5 mm or less. Indeed, the front sides of top, lateral sidewalls, and bottom wall of the outer housing 16 may all be spaced from the mechanical reference plane of the connector 10 by about 5 mm or less. Therefore, when the connector 10 is mated with the LC receptacle (e.g., adapter 210) such that their respective mechanical reference planes are aligned, the front side of the outer housing 16 is never more than about 0.5 mm from the adapter front wall 220 for this specific example.

Referring to both FIGS. 1 and 36, the concealing design of the outer housing 16 is complemented by the low profile of the outer housing 16 relative to the adapter 210. In the embodiment shown, for example, the outer housing 16 has a width that is less than the width of the adapter front wall 220. Additionally, the outer housing 16 has a height that is approximately the same as that of the adapter 210. FIG. 36 in particular shows how when the connector 10 is mated with the adapter 210, the top side of the outer housing 16 remains below a plane P1 that is aligned with a top of the adapter 210. Additionally, the bottom side of the outer housing 16 is located only slightly below a plane P2 that is aligned with a bottom side of the adapter 210. As a result of such a configuration, the connector 10 has a small profile/footprint in a plane transverse to the longitudinal axis A and can be used when adapters 210 or similar receptacles are positioned close together, as may be the case in dense patch panels, transceiver interfaces, etc. In particular, the small footprint of the connector 10 in planes orthogonal to the longitudinal axis A means that one connector 10 is unlikely to block or otherwise interfere with another connector 10 being plugged into a neighboring receptacle in such dense connectivity environments.

FIGS. 1 and 36 also show how the connector 10 may be compact in the axial direction as well, and thereby not take up much space in front of an adapter 210 or other component to which the connector 10 may be mated. The axially-compact design is facilitated by how the connector 10 has been designed to influence potential bending of the optical fibers that may occur in the connector 10 and/or cable 12 during use. There may be several causes for such potential bending. For example, as mentioned above, the ferrules 24 that terminate the optical fibers 22 are spring-biased by way of the springs 32 acting on the ferrule holders 26. When mating the connector 10 with another connector or with ferrules inside the ports of a transceiver or other equipment, physical contact may be established before the connector 10 is fully mated. The ferrules 24 then compress the springs 32 and retract relative to the connector bodies 28 to allow the connector 10 to reach its fully mated position. Because the optical fibers 22 are secured to the ferrules 24, the retraction also results in the optical fibers 22 being pushed back. To accommodate the excess length, the optical fibers 22 may bend more than normal to take a longer path of travel through other connector components (e.g., the inner housing 50) and/or the cable 12.

As another example, a cable assembly 14 that includes the connector 10 may experience a range of different environmental conditions in the field, including temperature fluctuations. Materials used in the construction of the cable jacket 68 may cause the cable jacket 68 to shrink in length slightly during some of the changes in environmental conditions. In such situations there is not a corresponding shrinkage of the lengths of the optical fibers 22 due to their different material properties, so there may then be excess length of the optical fibers 22 that needs to be accommodated in the cable assembly 14. Again, the optical fibers 22 may bend more than normal to take a longer path of travel through connector components and/or the cable 12.

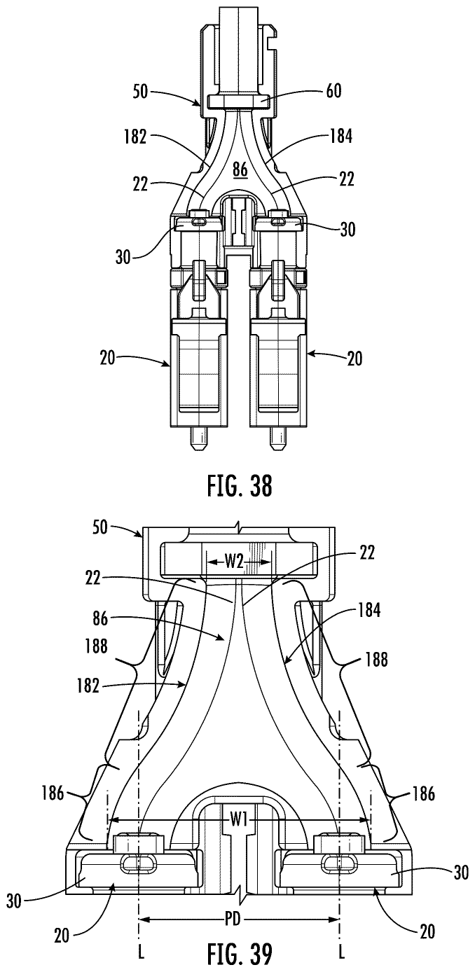

Applicant has found that by designing the inner cavity 86 of the inner housing 50 in a particular manner, increased bending of the optical fibers 22 can be directed in a preferential manner. More specifically, and with reference to FIGS. 38 and 39, the inner cavity 86 includes first and second lateral sides 182, 184 that each have a profile defined by a first arc-shaped segment 186 and a second arc-shaped segment 188. The first arc-shaped segment 186 extends a first length from a front region of the inner cavity 86 toward the rear of the inner cavity 86 and curves inward while extending to as to be concave relative to the inner cavity 86. Thus, the first arc-shaped segment 186 can be characterized as having a first radius of curvature R1. The second arc-shaped segment 188 extends a second length from a rear region of the inner cavity 86 toward the front of the inner cavity 86 and curves outward while extending so as to be convex relative to the inner cavity 86. Thus, the second arc-shaped segment 188 can be characterized as having a second radius of curvature R2. The terms “front region” and “rear region” are used in this disclosure to refer respectively to regions relatively close to a front and rear of the inner cavity 86 (the latter being adjacent the transition tube 60), such as including the first or last 15% of an axial length of the inner cavity 86. This is merely to account for slight variations from the embodiment shown, which includes the first and second arc-shaped segments 186, 188 extending essentially from the very front and rear of the inner cavity 86.

In the embodiment shown, the first arc-shaped segment 186 and second arc-shaped segment 188 are continuous to define an s-shaped curve and thereby result in the associated lateral side 182, 184 having an s-shaped profile. The s-shaped first and second lateral sides 182, 184 transition the inner cavity 86 from a first width W1 at a front of the inner cavity 86 to a smaller, second width W2 a rear of the inner cavity 86. The location at which the first arc-shaped segment 186 joins the second arc-shaped segment 188 may vary based on the particular design. In the example shown, the first and second arc-shaped segments 186, 188 are shaped at an intermediate width of the inner cavity 86, with the intermediate width being closer to the pitch distance PD between the connector sub-assembly axes L than to the first width W1.

The optical fibers 22 are shown in FIGS. 38 and 39 with a representative path of travel from the connector sub-assemblies 20 to the rear of the inner cavity 86. The exact path of travel may vary based on how the connector 10 was installed/assembled, but the general concept of the optical fibers 22 extending through the inner cavity 86 and while doing so transitioning from the connector sub-assemblies (which themselves are positioned at the pitch distance PD) to fit within the narrower, second width W2 at the rear of the inner cavity 86. If excess length of the optical fibers 22 needs to be accommodated in the cable assembly 14 (e.g., for one of the reasons mentioned above), the optical fibers may bend towards the first and/or second lateral sides 182, 184 of the inner cavity.

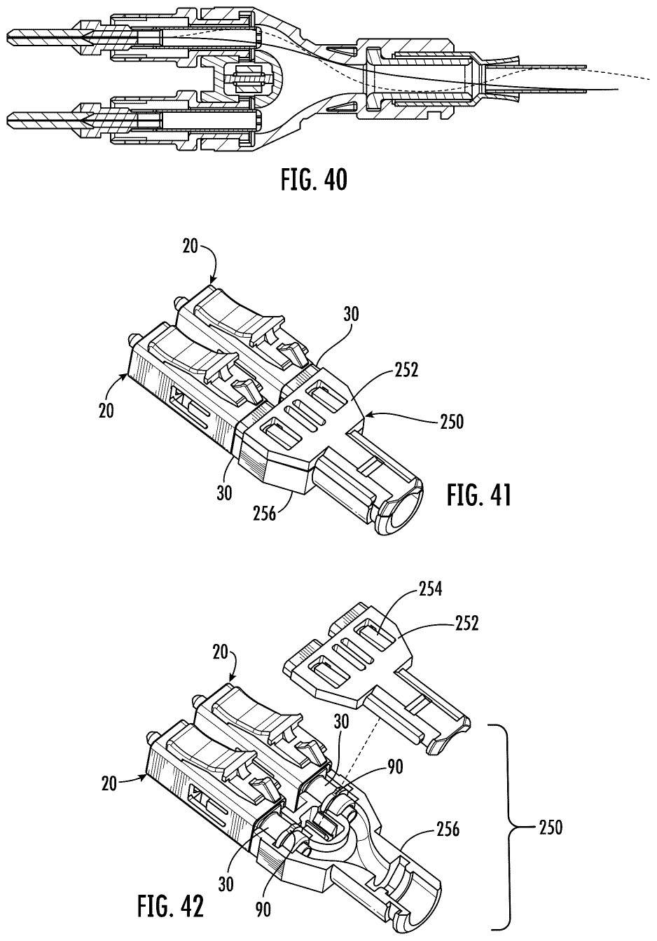

To this end, FIG. 40 is a schematic view showing one optical fiber 22 bending from a first path of travel (solid line) to take on a second path of travel (dashed line) when excess fiber length needs to be accommodated within the cable assembly 14 (e.g., for one of the reasons mentioned above). As can be appreciated, the optical fiber 22 may bend from the first path of travel and contact the lateral side 182, and particularly the second arc-shaped segment 186. The convex, curved nature of the second arc-shaped segment 188 helps direct the forces the optical fiber 22 is experiencing in an axial direction. Applicant has found this to be effective at causing the optical fiber 22 to bend/bow more along its path of travel through the cable 12 compared to conventional designs. In other words, by providing the convex, second arc-shaped segment 188 instead of a segment with a straight profile, more of the bending/bowing that the optical fiber 22 may experience to accommodate excess fiber length can get directed into the cable 12. The inner housing 50 and connector components behind the inner housing can then be kept relatively short in length since the connector 10 since the excess fiber length is better directed into the cable 12 compared to conventional designs.

Applicant has found the feature mentioned above to be particularly effective when R2 is approximately twice that of R1, such as R2 being in the range of 1.75 to 2.35 times R1. To provide an example of how compact the inner housing 50 may be, representative values for an axial distance between the front and rear of the inner cavity 86 will now be mentioned, along with representative values for R1 and R2. In some embodiments, the axial length of the inner cavity 86 (i.e., axial travel distance of the first and second lateral sides 182, 184) may be between 7.5 mm and 9.5 mm, with a specific example being about 8.5 mm). In some embodiments, the first radius of curvature R1 may be less than 5 mm, such as between 3 mm and 5 mm. A specific example is the first radius of curvature R1 being about 4 mm. Although the first radius of curvature R1 is constant along the first arc-shaped segment 186, embodiments are also possible where the first radius of curvature R1 varies as the first arc-shaped segment 186 extends along its first length. Similarly, in some embodiments the second radius of curvature R2 may be less than 10 mm, such as between 8 mm and 10 mm. A specific example is the second radius of curvature R2 being about 9 mm. Although the second radius of curvature R2 is constant along the second arc-shaped segment, embodiments are also possible where the second radius of curvature R2 varies as the second arc-shaped segment 188 extends along its second length.

It will be apparent to those skilled in optical connectivity that various modifications and variations can be made based on this disclosure. For example, although the outer housing 16 is described as substantially or completely concealing the inner housing 50 and connector sub-assemblies 20 when the connector 10 is mated with the adapter 210, other configurations are possible where this is not the case. Many of the features provided in this disclosure can also apply to connectors without the “pull anywhere” configuration described above and/or to connectors where an outer housing does not completely surround an inner housing. The outer housing 16 can therefore be more generically considered as an outer body since the nature in which the component houses/covers the inner housing 50 and portions of the connector sub-assemblies 20 may be different in other embodiments.

As another example, in the description above relating to the inner housing 50 holding rear portions of the connector sub-assemblies 20, it was mentioned that alternative embodiments may include the lid 80 having flexible extension members to provide additional or alternative engagement with the connector sub-assemblies 20. FIGS. 40 and 41 illustrate one example of such an alternative. In particular, FIGS. 40 and 41 illustrate an inner housing 250 that provides functionality similar to the inner housing 50, but with a different configuration. The inner housing 250 includes a lid 252 having flexible extension members in the form of arms 254, which are configured to engage the notches 90 on the rear stopper components 30. The arms 254 function in substantially the same way as the flexible tabs 92 (FIGS. 10 and 11) to index the rear stopper components 30 (and connector sub-assemblies 20 in general) to different rotational positions about the respective connector sub-assembly axes L. Accordingly, a base 256 of the inner housing 250 need not include locking features for engaging the notches 90.

As yet another example of variations within the scope of this disclosure, and as mentioned at the beginning of this Detailed Description section, although the connector 10 described above and shown in the figures is in the form of an LC duplex uniboot connector, various features disclosed may be applicable to different connector configurations and different connector sub-assembly designs. This includes simplex configurations of LC connectors, and both simplex and duplex configurations of different (i.e., non-LC) connector designs. Indeed, in the claims that follow, the use of “a” or “an” in connection with an element (e.g., a connector sub-assembly) refers to “one or more” of the element unless explicitly stated otherwise.

Also in the claims that follow, and this disclosure in general, persons skilled in optical connectivity will appreciate that references to intermateabiltiy/interface standards need not include the exact year/revision of such standards, since the dimensional relationships pertinent to this disclosure may be applicable to all revisions, past and future. Applicant references specific revisions above, namely IEC 61754-20:2012+AMD1:2022 and TIA/EIA 604-10-C:2021 for LC-type optical interfaces, merely as examples applicable as of the filing date of this disclosure.

What is claimed is:

1. An optical connector, comprising:
a first connector sub-assembly that is configured to terminate a first optical fiber;
a second connector sub-assembly that is configured to terminate a second optical fiber;
an inner housing that holds a rear portion of the first connector sub-assembly and a rear portion of the second connector sub-assembly so that the first connector sub-assembly and the second connector sub-assembly extend forward from a front portion of the inner housing;
an outer housing positioned over at least a rear portion of the inner housing; and
a boot extending rearward from the outer housing;
wherein:
the outer housing is movable along a longitudinal axis of the optical connector and relative to the inner housing between a forward position and a rear position, the boot being axially coupled to the outer housing so that the boot is configured to move with the outer housing along the longitudinal axis; and
the inner housing includes at least one stopping feature configured to contact the outer housing when the outer housing is moved to the rear position, the at least one stopping feature being configured to retain the outer housing on at least the rear portion of the inner housing.

2. The optical connector of claim 1, wherein the outer housing is rotatable relative to the inner housing about the longitudinal axis when the outer housing is in the rear position but not when the outer housing is in the forward position.

3. The optical connector of claim 2, wherein the outer housing has an axial travel length between the forward position and the rear position, and wherein the inner housing is configured to prevent the outer housing from rotating relative to the inner housing about the longitudinal axis for at least 50% of the axial travel length.

4. The optical connector of claim 2, wherein:
the outer housing includes an inner wall that defines a flange; and
the rear portion of the inner housing includes a groove that extends at least partially in a circumferential direction about the longitudinal axis and that is configured to receive the flange when the outer housing is in the rear position and rotated about the longitudinal axis.

5. The optical connector of claim 2, wherein in the rear position, the outer housing is rotatable 180 degrees about the longitudinal axis between a first orientation and a second orientation, and wherein the inner housing is configured to allow the outer housing to rotate in only one direction from the first orientation to the second orientation and in only an opposite direction from the second orientation to the first orientation.

6. The optical connector of claim 5, wherein the inner housing is configured to substantially prevent relative movement of the outer housing along the longitudinal axis when the outer housing is rotating between the first orientation and the second orientation.

7. The optical connector of claim 1, wherein the first connector sub-assembly and the second connector sub-assembly each include a connector body having a main portion and a latch arm that extends over the main portion, and further wherein:
when the outer housing is in the forward position, the outer housing extends partially over the latch arms of the first connector sub-assembly and the second connector sub-assembly; and
the outer housing is configured to cause the latch arms to flex toward the main portion of the respective connector body when the outer housing moves along the longitudinal axis from the forward position towards the rear position.

8. The optical connector of claim 7, wherein the connector body of the first connector sub-assembly and the connector body of the second connector sub-assembly are configured to rotate relative to the inner housing about a respective connector sub-assembly axis, and further wherein:
the first connector sub-assembly and the second connector sub-assembly each further include a ferrule configured to support at least one optical fiber;
at least a portion of the ferrule is surrounded by the corresponding connector body; and
the ferrule and the connector body are configured to rotate together about the respective connector sub-assembly axis.

9. The optical connector of claim 8, wherein the rear portions of the first and second connector sub-assemblies are held by the inner housing in a manner that allows the rear portions to rotate about the respective connector sub-assembly axis.

10. The optical connector of claim 1, wherein the rear portions of the first and second connector sub-assemblies are held by the inner housing in a manner that allows the rear portions to rotate about a respective connector sub-assembly axis, and further wherein for each of the first and second connector sub-assemblies:
the rear portion thereof includes a plurality of rotation locking features circumferentially arranged about the respective connector sub-assembly axis; and
the inner housing includes at least one complementary locking feature configured to releasably engage at least one of the rotation locking features so that the respective connector sub-assembly can be indexed to different rotational positions about the respective connector sub-assembly axis.

11. The optical connector of claim 10, wherein for each of the first and second connector sub-assemblies:
the rear portion thereof includes a radial flange with a plurality of notches that define the plurality of rotation locking features; and
the at least one complementary locking feature on the inner housing comprises a flexible member that releasably engages at least one of the notches in each of the different rotational positions to which the respective connector sub-assembly can be indexed.

12. The optical connector of claim 1, wherein the inner housing is configured to extend into ports of a receptacle when the optical connector is mated with the receptacle.

13. The optical connector of claim 1, wherein:
the boot comprises a substrate formed from a first material and a strain relief component formed from a second material that is less rigid than the first material;
the strain relief component is received over a portion of the substrate;
the substrate extends through an opening in a rear wall of the outer housing and defines a flange; and
the rear wall of the outer housing is positioned between the flange of the substrate and the strain relief component.

14. The optical connector of claim 1, wherein:
the boot is rotatable relative to the outer housing about the longitudinal axis between a first rotational position and a second rotational position;
in the first rotational position, the boot and the inner housing are configured to limit relative axial movement to substantially prevent the outer housing from moving away from the forward position; and
in the second rotational position, the boot and the inner housing are configured to permit relative axial movement so that the outer housing can move rearward with the boot when the boot is moved to the rear position.

15. The optical connector of claim 14, wherein:
the boot includes a locking arm having a catch;
in the first rotational position of the boot, the catch is configured to contact the at least one stopping feature of the inner housing to limit relative movement between the boot and the inner housing along the longitudinal axis and thereby also limit relative movement between the outer housing and the inner housing along the longitudinal axis; and
in the second rotational position of the boot, the catch is not configured to contact the at least one stopping feature of the inner housing to permit relative movement between the boot and the inner housing along the longitudinal axis.

16. The optical connector of claim 1, wherein:
the first connector sub-assembly and the second connector sub-assembly each extend along a respective connector sub-assembly axis;
the inner housing also includes an inner cavity that extends from the first and second connector sub-assemblies toward the rear portion of the housing; and
in a transverse plane that extends through the inner housing and the connector sub-assembly axes:
the inner cavity includes first and second lateral sides that transition the inner cavity from a first width at a front region of the inner cavity to a second width at a rear region the inner cavity, with the second width being less than a pitch distance between the connector sub-assembly axes, and
the first and second lateral sides each have a profile defined by at least an arc-shaped segment that extends from the rear region of the inner cavity toward the front region and that curves outward so as to be convex relative to the inner cavity.

17. The optical connector of claim 16, wherein for each of the first and second lateral sides, the respective arc-shaped segment that extends from the rear region of the inner cavity has a radius of curvature of between 8 mm and 10 mm along a length of the arc-shaped segment.

18. The optical connector of claim 16, wherein:
for each of the first and second lateral sides, the respective arc-shaped segment that extends from the rear region of the inner cavity is a second arc-shaped segment;
the profiles for the first and second lateral sides are each further defined by a respective first arc-shaped segment that extends from the front region of the inner cavity toward the rear region of the inner cavity; and
the first arc-shaped segments extend a first length and curve inward so as to be concave relative to the inner cavity.

19. The optical connector of claim 18, wherein the first radius of curvature of each of the first arc-shaped segments is between 3 mm and 5 mm.

20. The optical connector of claim 16, wherein for each of the first and second lateral sides, the first arc-shaped segment and the second arc-shaped segment are continuous and define an s-shaped curve.

21. The optical connector of claim 16, wherein the second width is less than one-fourth of the first width.

22. The optical connector of claim 1, wherein the first connector sub-assembly and the second connector sub-assembly each comprises an LC connector according to IEC 61754-20 or TIA/EIA 604-10.
